(19) United States
(12) Patent Application Publication
(10) Pub. No.: US 2012/0096405 A1
(43) Pub. Date: Apr. 19, 2012

(54) APPARATUS AND METHOD FOR DIET MANAGEMENT

(76) Inventor: Dongkyu SEO, Seoul (KR)

(21) Appl. No.: 12/972,282

(22) Filed: Dec. 17, 2010

(30) Foreign Application Priority Data
Oct. 15, 2010 (KR) 10-2010-0100613

(51) Int. Cl. G06F 3/048

(52) U.S. Cl. 715/825

(57) ABSTRACT

The present invention relates to an apparatus and method for diet management. More particularly, the present invention relates to an apparatus and method for diet management for deciding a target menu according to an input selecting at least a portion of the overall menu, and calculating the calories of the target menu, and providing corresponding information

### CROSS-REFERENCE TO RELATED APPLICATIONS

This application claims priority to Korean Patent Application No. 10-2010-0100613, filed on Oct. 15, 2010, and is herein incorporated by reference in its entirety.

### BACKGROUND OF THE INVENTION

1. Field of the Invention

The present invention relates to an apparatus and method for diet management. More particularly, the present invention relates to an apparatus and method for diet management for deciding a target menu according to an input selecting at least a portion of the overall menu, and calculating the calories of the target menu, and providing corresponding information.

2. Description of the Related Art

As society is advancing, people are becoming more interested in their health. In particular, as a well-being culture socially emerges, demand for a diet management service is explosively increasing.

### BRIEF SUMMARY OF THE INVENTION

The problems to be solved by the present invention are as follows.

An aspect of the present invention provides an apparatus and a method for a diet management capable of capturing an image of a menu and outputting calories of the menu.

Another aspect of the present invention provides an apparatus and a method for a diet management capable of improving user convenience in selecting a food category of food items included in a menu (or diet or meals).

Another aspect of the present invention provides an apparatus and a method for a diet management capable of analyzing various kinds of menus.

Another aspect of the present invention provides an apparatus and a method for a diet management capable of allowing a user to select a food category of a plurality of food items of a menu, thus improving user convenience.

Another aspect of the present invention provides an apparatus and a method for a diet management capable of capturing an image of a menu and providing comprehensive information for a user's health as well as the calories of the menu.

Another aspect of the present invention provides an apparatus and a method for a diet management capable of providing the calories regarding a portion of a menu.

Another aspect of the present invention provides an apparatus and a method for a diet management capable of accurately recognizing the amount of food ingested by a user and providing accurate calories of the ingested food.

Another aspect of the present invention provides an apparatus and a method for a diet management capable of communicating with a diet management server, or the like, to provide comprehensively analyzed health guide information.

Another aspect of the present invention provides an apparatus and a method for a diet management capable of providing accurate calories of a menu in consideration of the distance to the menu.

According to an aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; and a controller configured to: decide a target menu including the first at least one food item based on the first signal, calculate calories of the target menu, and output the calculated calories of the target menu.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; and a controller configured to: decide a target menu including the first at least one food item based on the first signal, calculate calories of the target menu, and output the calculated calories of the target menu. Herein, the first signal is a signal for selecting a first area from the entire area of the displayed overall menu, and the first area is an area in which the first at least one food item is displayed.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; and a controller configured to: decide a target menu including the first at least one food item based on the first signal, calculate calories of the target menu, and output the calculated calories of the target menu. Herein, the first signal is a signal for selecting a first area from the entire area of the displayed overall menu, and the first area is an area in which the first at least one food item is displayed. Also, herein, the input module receives a second signal for selecting second at least one food item from the displayed overall menu, and the controller changes the target menu according to the second signal, calculates calories of the changed target menu, and controls the output module to output the calculated calories of the changed target menu.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; and a controller configured to: decide a target menu including the first at least one food item based on the first signal, calculate calories of the target menu, and output the calculated calories of the target menu. Herein, the first signal is a signal for selecting a first area from the entire area of the displayed overall menu, and the first area is an area in which the first at least one food item is displayed. Also, herein, the input module receives a second signal for selecting second at least one food item from the displayed overall menu, and the controller: adds a food item to the target menu, the food item included in the second at least one food item and not included in the target menu; excludes a food item from the target menu, the food item included in the at second least one food item and included in the target menu; calculates calories of the changed target menu; and controls the output module to output the calculated calories of the changed target menu.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; a communication module configured to communicate with a diet management server; and a controller configured to: transmit the captured image of the overall menu and the first signal to the diet management server via the communication module, receive calories of a target menu including first at least one food item from the diet management server via the communication module, and control the output module to output the calories of the target menu. Herein, the diet management server decides the target menu including the first at least one food item according to the first signal, and calculates the calories of the target menu based on the image of the overall menu.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; a communication module configured to communicate with a diet management server; and a controller configured to: transmit the captured image of the overall menu and the first signal to the diet management server via the communication module, receive calories of a target menu including first at least one food item from the diet management server via the communication module, and control the output module to output the calories of the target menu. Herein, the diet management server decides the target menu including the first at least one food item according to the first signal, and calculates the calories of the target menu based on the image of the overall menu. Also, herein the input module receives a second signal for selecting second at least one food item from the displayed overall menu, the controller transmits the second signal to the diet management server via the communication module, and the diet management server changes the target menu according to the second signal.

According to another aspect of the present invention, an apparatus for a diet management comprises: a camera configured to capture an image of an overall menu including at least one food item; an output module configured to display the overall menu; an input module configured to receive a first signal for selecting first at least one food item from the displayed overall menu; a communication module configured to communicate with a diet management server; and a controller configured to: transmit the captured image of the overall menu and the first signal to the diet management server via the communication module, receive calories of a target menu including first at least one food item from the diet management server via the communication module, and control the output module to output the calories of the target menu. Herein, the diet management server decides the target menu including the first at least one food item according to the first signal, and calculates the calories of the target menu based on the image of the overall menu. Also, herein, the controller: receives diet guide information from the diet management server via the communication module, and controls the output module to output the diet guide information. And herein, the diet management server: stores a user's physical information, and generates the diet guide information based on the physical information and the calories of the target menu.

According to another aspect of the present invention, a method for a diet management comprises: capturing an image of an overall menu including at least one food item; displaying the captured image of the overall menu; receiving a first signal for selecting first at least one food item from the displayed overall menu; deciding a target menu including the first at least one food item according to the first signal; calculating calories of the target menu; and outputting the calculated calories of the target menu.

According to another aspect of the present invention, a method for a diet management comprises: capturing an image of an overall menu including at least one food item; displaying the captured image of the overall menu; receiving a first signal for selecting first at least one food item from the displayed overall menu; deciding a target menu including the first at least one food item according to the first signal; calculating calories of the target menu; and outputting the calculated calories of the target menu. Herein, the method for a diet management further comprises: receiving a second signal for selecting at least one second food item from the displayed overall menu; changing the target menu according to the second signal; calculating the calories of the changed target menu; and outputting the calculated calories of the changed target menu.

According to another aspect of the present invention, a method for a diet management comprises: capturing an image of an overall menu including at least one food item; displaying the captured image of the overall menu; receiving a first signal for selecting first at least one food item from the displayed overall menu; deciding a target menu including the first at least one food item according to the first signal; calculating calories of the target menu; and outputting the calculated calories of the target menu. Herein, the method for a diet management further comprises: storing a user's physical information; generating diet guide information based on the physical information and the calories of the target menu; and outputting the diet guide information.

The present invention has the following advantages.

According to exemplary embodiments of the present invention, the apparatus for a diet management determines the kind of a food item according to a captured image of a menu and an input related to a food category, calculates the calories of the menu, and provides the calories information to the user. Thus, the user can recognize the calories of the menu.

According to exemplary embodiments of the present invention, the user can receive the calories of a menu, adjust his or her dietary life according to the received calories of the menu, and adjusts his meal suitably according to his or her health and disease management.

According to exemplary embodiments of the present invention, because the apparatus for a diet management provides an appropriate food category according to various kinds of menus to the user, the user can more conveniently decide a food category of a food item.

According to exemplary embodiments of the present invention, because the apparatus for a diet management calculates the calories of a menu in consideration of the amount of a food item as well as the kind of the food item, it can provide accurate calories of a menu to the user.

According to exemplary embodiments of the present invention, because the apparatus for a diet management provides a customized diet guide information to the user in consideration of various kinds of information such as the kind of a food item, the calories of a menu, comprehensively, rather than providing only the simple calories of a menu, the user can effectively perform a diet management.

According to exemplary embodiments of the present invention, the user can recognize the calories regarding a portion of the overall menu.

According to exemplary embodiments of the present invention, because the calories regarding a portion of a menu is provided to the user, the user can variably select a portion of the menu, receive corresponding calories information, and recognize which of food items among the overall menu will be desirous for his or her ingestion.

According to exemplary embodiments of the present invention, when there are a plurality of food items on a menu, the apparatus for a diet management selects a food category of food items belonging to the same food category, rather than selecting a food category with respect to each of the food items, so the user can conveniently select the food category.

According to exemplary embodiments of the present invention, the apparatus for a diet management calculates an accurate amount of ingested food by comparing a menu before a meal and a menu after the meal to provide the calculated accurate amount of ingested food.

According to exemplary embodiments of the present invention, the apparatus for a diet management provides guide information regarding for an image capture distance to allow the user to capture a menu at an appropriate distance to calculate an accurate calories of ingested food.

According to exemplary embodiments of the present invention, the apparatus for a diet management calculates the calories of a menu in consideration of the distance at which an image of a menu was captured, so the accurate calories of the menu can be calculated.

According to exemplary embodiments of the present invention, the apparatus for a diet management provides information regarding health, e.g., exercise guide information, and the like, besides diet guide information, so the user can comprehensively manage his or her health.

According to exemplary embodiments of the present invention, the apparatus for a diet management provides accurately analyzed information obtained from an external device having good performance by transmitting and receiving information regarding a diet management to and from the external device to the user, so the information can be provided to the user more quickly and accurately.

According to exemplary embodiments of the present invention, because the apparatus for a diet management provides image capture guide information to the user, the user can easily capture an image and obtain accurate images of a menu and food items.

According to exemplary embodiments of the present invention, because the apparatus for a diet management calculates the calories of a menu in consideration of the distance to the menu, accurate calories of the menu can be calculated.

According to exemplary embodiments of the present invention, because the user can be provided with a service related to a health management by using the apparatus for a diet management, the user can live a more healthy life and medical costs that may be otherwise unnecessarily wasted at a social level can be saved.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view of an apparatus for a diet management according to an exemplary embodiment of the present invention.

FIG. 2 is a schematic block diagram of the apparatus for a diet management according to an exemplary embodiment of the present invention.

FIG. 3 is a view illustrating a camera of the apparatus for a diet management according to an exemplary embodiment of the present invention.

FIG. 4 is a view illustrating an output module of the apparatus for a diet management according to an exemplary embodiment of the present invention.

FIG. 5 is a first view illustrating an input module of the apparatus for a diet management according to an exemplary embodiment of the present invention.

FIG. 6 is a second view illustrating the input module of the apparatus for a diet management according to an exemplary embodiment of the present invention.

FIG. 7 is a view illustrating a communication module of the apparatus for a diet management according to an exemplary embodiment of the present invention.

FIG. 8 is a flow chart illustrating the process of a method for a diet management according to a first exemplary embodiment of the present invention.

FIG. 9 is a first view illustrating an input for matching a food item image to an object in the method for a diet management according to the first exemplary embodiment of the present invention.

FIG. 10 is a second view illustrating an input for matching a food item image to an object in the method for a diet management according to the first exemplary embodiment of the present invention.

FIG. 11 is a third view illustrating an input for matching a food item image to an object in the method for a diet management according to the first exemplary embodiment of the present invention.

FIG. 12 is a view illustrating kinds of food items belonging to food categories according to the first exemplary embodiment of the present invention.

FIG. 13 is a view illustrating selecting of the kind of a food item in the method for a diet management according to the first exemplary embodiment of the present invention.

FIG. 14 is a flow chart illustrating the process of a method for a diet management according to a second exemplary embodiment of the present invention.

FIG. 15 is a view illustrating selecting of kinds of menus in the method for a diet management according to the second exemplary embodiment of the present invention.

FIG. 16 is a view illustrating food categories belonging to the kinds of menus in the method for a diet management according to the second exemplary embodiment of the present invention.

FIG. 17 is a first view illustrating an output of food categories belonging to the kinds of menus in the method for a diet management according to the second exemplary embodiment of the present invention.

FIG. 18 is a second view illustrating an output of food categories belonging to the kinds of menus in the method for a diet management according to the second exemplary embodiment of the present invention.

FIG. 19 is a flow chart illustrating the process of a method for a diet management according to a third exemplary embodiment of the present invention.

FIG. 20 is a view illustrating determining of the amount of food items in the method for a diet management according to the third exemplary embodiment of the present invention.

FIG. 21 is a flow chart illustrating the process of a method for a diet management according to a fourth exemplary embodiment of the present invention.

FIG. 22 is a first view illustrating an output of diet guide information in the method for a diet management according to a fourth exemplary embodiment of the present invention.

FIG. 23 is a second view illustrating an output of diet guide information in the method for a diet management according to a fourth exemplary embodiment of the present invention.

FIG. 24 is a third view illustrating an output of diet guide information in the method for a diet management according to a fourth exemplary embodiment of the present invention.

FIG. 25 is a flow chart illustrating the process of a method for a diet management according to a fifth exemplary embodiment of the present invention.

FIG. 26 is a first view illustrating selecting of at least a portion of a menu in the method for a diet management according to the fifth exemplary embodiment of the present invention.

FIG. 27 is a second view illustrating selecting of at least a portion of a menu in the method for a diet management according to the fifth exemplary embodiment of the present invention.

FIG. 28 is a first view changing selecting of at least a portion of a menu in the method for a diet management according to the fifth exemplary embodiment of the present invention.

FIG. 29 is a second view illustrating changing of at least a portion of a menu in the method for a diet management according to the fifth exemplary embodiment of the present invention.

FIG. 30 is a flow chart illustrating the process of a method for a diet management according to a sixth exemplary embodiment of the present invention.

FIG. 31 is a view illustrating setting of a food group in the method for a diet management according to the sixth exemplary embodiment of the present invention.

FIG. 32 is a view illustrating adding of a food group in the method for a diet management according to the sixth exemplary embodiment of the present invention.

FIG. 33 is a view illustrating excluding of a food group in the method for a diet management according to the sixth exemplary embodiment of the present invention.

FIG. 34 is a view illustrating matching of a food group to an object in the method for a diet management according to the sixth exemplary embodiment of the present invention.

FIG. 35 is a flow chart illustrating the process of a method for a diet management according to a seventh exemplary embodiment of the present invention.

FIG. 36 is a view illustrating a first menu image regarding a menu at a first time point in the method for a diet management according to the seventh exemplary embodiment of the present invention.

FIG. 37 is a view illustrating a second menu image regarding a menu at a second point in time in the method for a diet management according to the seventh exemplary embodiment of the present invention.

FIG. 38 is a view illustrating determining of the amount of ingested food in the method for a diet management according to the seventh exemplary embodiment of the present invention.

FIG. 39 is a view illustrating an output of diet guide information and exercise guide information in the method for a diet management according to the seventh exemplary embodiment of the present invention.

FIG. 40 is a flow chart illustrating the process of a method for a diet management according to an eighth exemplary embodiment of the present invention.

FIG. 41 is a view illustrating detection of the distance to a menu in the method for a diet management according to the eighth exemplary embodiment of the present invention.

FIG. 42 is a view illustrating an output of image capture guide information in the method for a diet management according to the eighth exemplary embodiment of the present invention.

FIG. 43 is a flow chart illustrating the process of a method for a diet management according to a ninth exemplary embodiment of the present invention.

FIG. 44 is a view illustrating a communication module in the method for a diet management according to the ninth exemplary embodiment of the present invention.

### DETAILED DESCRIPTION OF THE INVENTION

The terminology used herein is for the purpose of describing particular embodiments only and is not intended to be limiting of the invention.

The present invention may be embodied in many different forms and may have various embodiments, of which particular ones will be illustrated in drawings and will be described in detail. However, it should be understood that the following exemplifying description of the invention is not meant to restrict the invention to specific forms of the present invention but rather the present invention is meant to cover all modifications, similarities and alternatives which are included in the spirit and scope of the present invention.

The same reference numerals will be used throughout to designate the same or like components, and a repeated description may be omitted.

The present invention is not limited to the exemplary embodiments described hereinafter.

Exemplary embodiments of the present invention will now be described with reference to the accompanying drawings.

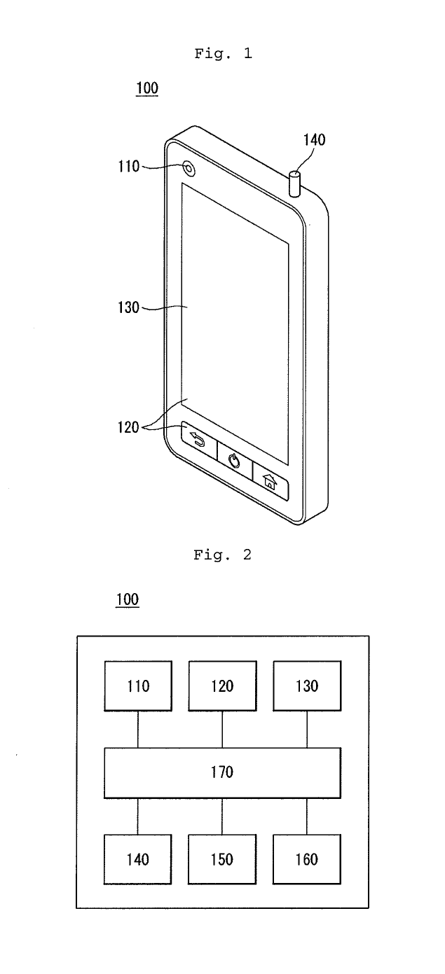

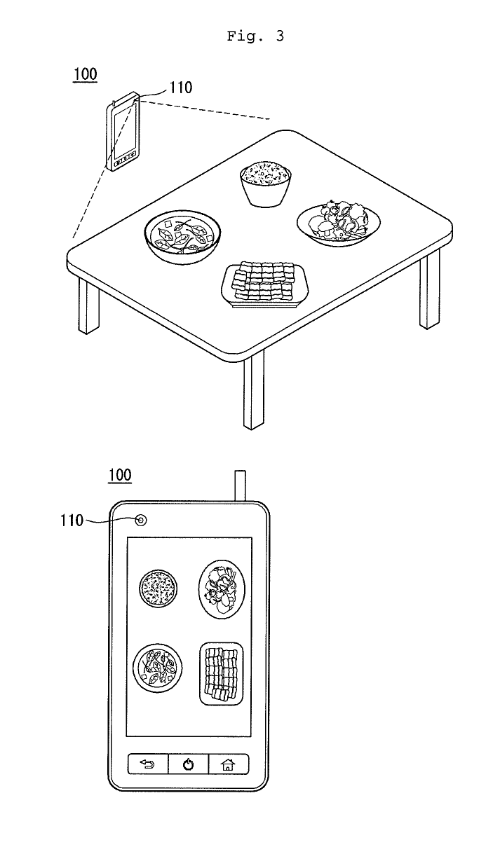

An apparatus for a diet management according to an exemplary embodiment of the present invention will now be described with reference to FIG. 1 and FIG. 2. FIG. 1 is a perspective view of an apparatus for a diet management according to an exemplary embodiment of the present invention and FIG. 2 is a schematic block diagram of the apparatus for a diet management according to an exemplary embodiment of the present invention.

The apparatus for a diet management 100 may allow the user to manage his or her diet. Here, the diet management may refer to controlling ingest of meal or food items in order to treat an illness or keep his or her healthy. For example, a chronic invalid who suffer from illness such as a metabolic syndrome, hypertension, diabetes, and the like, need to control his or her usual eating habits to manage the illness, and in this case, the person may use the apparatus 100 for a diet management for his or her diet management. In addition, even a healthy person may control his or her eating habits for diverse purposes such as maintaining his or her health, managing shape, and the like, and in this case, the person may use the apparatus 100 for a diet management for his or her diet management.

The apparatus 100 for a diet management captures an image of a menu and provides corresponding calories of the menu and other diet guide information to allow the user to control food or a diet. As shown in FIGS. 1 and 2, the apparatus 100 for a diet management according to an exemplary embodiment of the present invention may comprising at least one of a camera 110 capturing an image of a menu, an output module providing information for determining the kind of a food item by using an image captured by the camera 110, or the like, and outputting information for a diet management such as the calories of the menu or other diet guide information, an input module 120 receiving a signal for determining the kind of a food item included in the menu and other information for a diet management, a communication module 140 communicating with an external device to transmit and receive various kinds of information for a diet management, a storage unit 150 storing various kinds of information for a diet management, a distance detection unit 160 measuring the distance to the menu, and a controller 170 determining the kind or amount of a food item, calculating the calories of the menu based on the determined kind or amount of the food item, obtaining diet guide information, and controlling other elements of the apparatus 100 for a diet management. The apparatus 100 for a diet management according to an exemplary embodiment of the present invention may not necessarily comprise all the foregoing elements, and may selectively comprise the foregoing elements.

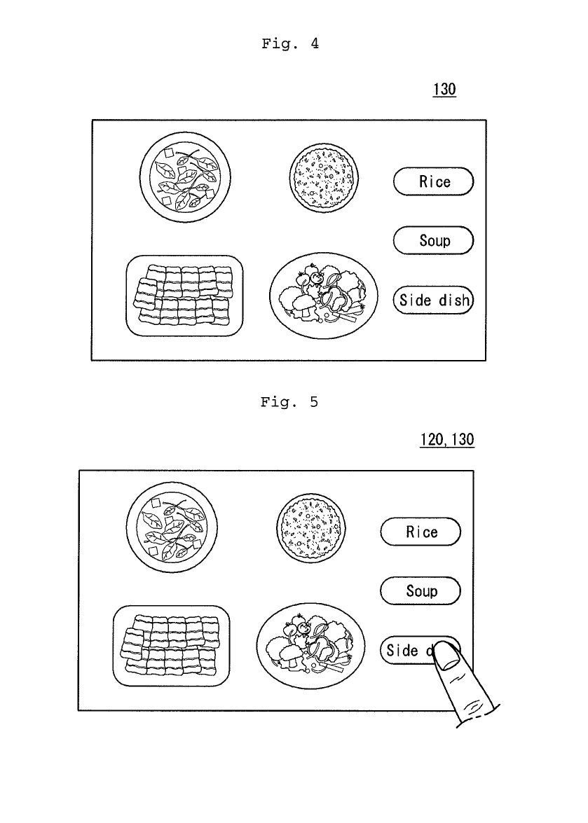

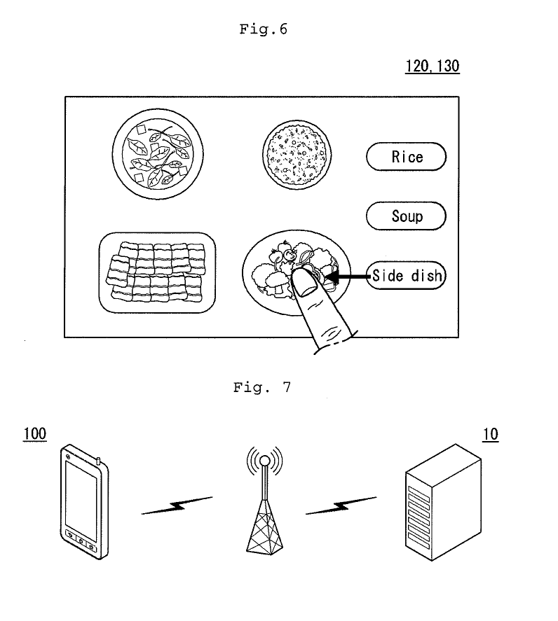

The respective elements of the apparatus 100 for a diet management according to an exemplary embodiment of the present invention will now be described with reference to FIGS. 3 to 7, in the order of the camera, 110, the output module 130, the input module 120, the communication module 140, the storage unit 150, and the controller 170. FIG. 3 is a view illustrating the camera 110 of the apparatus 100 for a diet management according to an exemplary embodiment of the present invention, FIG. 4 is a view illustrating the output module 130 of the apparatus 100 for a diet management according to an exemplary embodiment of the present invention, FIG. 5 is a first view illustrating the input module 120 of the apparatus 100 for a diet management according to an exemplary embodiment of the present invention, FIG. 6 is a second view illustrating the input module 120 of the apparatus 100 for a diet management according to an exemplary embodiment of the present invention, and FIG. 7 is a view illustrating the communication module 140 of the apparatus 100 for a diet management according to an exemplary embodiment of the present invention.

The camera 110 may capture an image of a menu. Here, the menu may include one or more food items. For example, the menu may include food items such as boiled rice, uncurdled bean curd soup, salad, roast meat (or Bulgogi) as shown in FIG. 3.

The camera 110 may capture an image of the menu to obtain a menu image. Here, the menu image may be a still image or video including at least one food item image. For example, as shown in FIG. 3, the camera 110 may capture the image of the menu as shown in FIG. 3 to obtain the menu image including food item images regarding the boiled rice, uncurdled bean curd soup, salad, roast meat (or Bulgogi).

The output module 130 may output information to the exterior. Accordingly, the user may receive the information from the apparatus 100 for a diet management. The output module 130 may output according to various methods. The output module 130 may output the information by using a visual signal, an audible signal, and a haptic signal. The output module 130 may include at least one of a display, a speaker, a vibrator, and various other output devices.

The output module 130 may provide various types of information. Here, the output module 130 may output an interface for determining the kind of a food item by using the image captured by the camera 110 or information for a diet management including diet guide information. For example, the output module 130 may display the food item image captured by the camera 110 and an object reflecting a food category.

The input module 120 may receive information from a user. The input module 120 may receive the information according to various methods. The input module 120 may receive the information according to at least one of a signal generated as a keyboard is pressed, a touch signal, a gesture signal, a voice signal, an image signal, and the like. The input module 120 may include at least one of a keyboard, a mouse, a touch screen, a microphone, and various other input devices.

The input module 120 may receive various types of information or signals. Here, the input module 120 may receive a signal for determining the kind of a food item included in the menu and information for a diet management. For example, when the output module 130 displays a menu image including food item images and objects reflecting a food category as shown in FIGS. 5 and 6, the input module 120 may receive a touch signal for selecting one of the displayed objects as shown in FIG. 5 or a touch signal for drag-and-dropping one of the displayed objects to one of the food item images.

The communication module 140 may perform communication with an external device. Here, the external device may include at least one of a diet management server 10, a mobile communication terminal, a personal computer, and various sites on the Internet, and the like. The communication module 140 may perform communication with various external devices through a wired/wireless network in various manners. For example, the communication module 140 may perform wireline communication such as a universal serial bus (USB), an RS-232 scheme, and the like. For another example, the communication module 140 may perform wireless communication such as Wi-Fi, WiBro, Bluetooth™, ZigBee™, RFID, IrDA, and the like. The method according to which the communication module 140 performs communication is not limited to the foregoing examples but may include various other methods of transmitting and receiving information to and from an external device.

The communication module 140 may transmit and receive various types of information for a diet management. For example, as shown in FIG. 7, the communication module 140 may transmit a food item image and a food category to the diet management server 10 and receive the kind of food, the calories of a menu, and at least one of various types of diet guide information.

The storage unit 150 may store information. The storage unit 150 may include various storage mediums. For example, the storage unit 150 may include at least one of a flash memory, a RAM, a ROM, a hard disk, an SD card, an optical disk such as a CD or a Blu-ray disk, and various other storage mediums. The storage unit 150 may be fixed inside of the apparatus 100 for a diet management or may be configured to be detachably mounted in the apparatus 100 for a diet management.

The storage unit 150 may store information related to a diet management. The storage unit 150 may receive information from at least one of the input module 120, the communication module 140, the controller 170, and the like, and store the received information. The information related to the diet management may include at least one of a menu image, a food item image, the kind of food, a food category, the kind of a menu, the kind of a food item, the amount of a food item, calories of a menu, the user's physical information, diet guide information, and various types of other information.

The distance detection unit 160 may measure the distance to the menu or at least one food. The distance detection unit 160 may include a sensor for sensing (or detecting) a distance. Here, the sensor for detecting a distance may measure the distance by using an optical scheme. For example, the sensor may measure the distance such that it irradiates light and receives reflected light of the irradiated light. The distance detection unit 160 may be integrally formed with the camera 110. The distance detection unit 160 may generate a signal reflecting the detected distance and deliver the generated signal to the controller 170.

The controller 170 determines the kind of amount of a food item, calculates the calories of a menu, obtains diet guide information, and controls other elements of the apparatus 100 for a diet management, to perform a diet management. Details of the controller 170 will be described in explaining a method for a diet management according to an exemplary embodiment of the present invention.

A method for a diet management according to an exemplary embodiment of the present invention will now be described.

The method for a diet management according to an exemplary embodiment of the present invention will be described by using the apparatus 100 for a diet management. Here, the apparatus 100 for a diet management is used to easily explain the method for a diet management according to an exemplary embodiment of the present invention. Thus, the method for a diet management according to an exemplary embodiment of the present invention is not limited by the apparatus 100 for a diet management according to an exemplary embodiment of the present invention.

The method for a diet management according to an exemplary embodiment of the present invention may be performed by using a different apparatus that performs the same function as that of the apparatus 10 for a diet management according to an exemplary embodiment of the present invention.

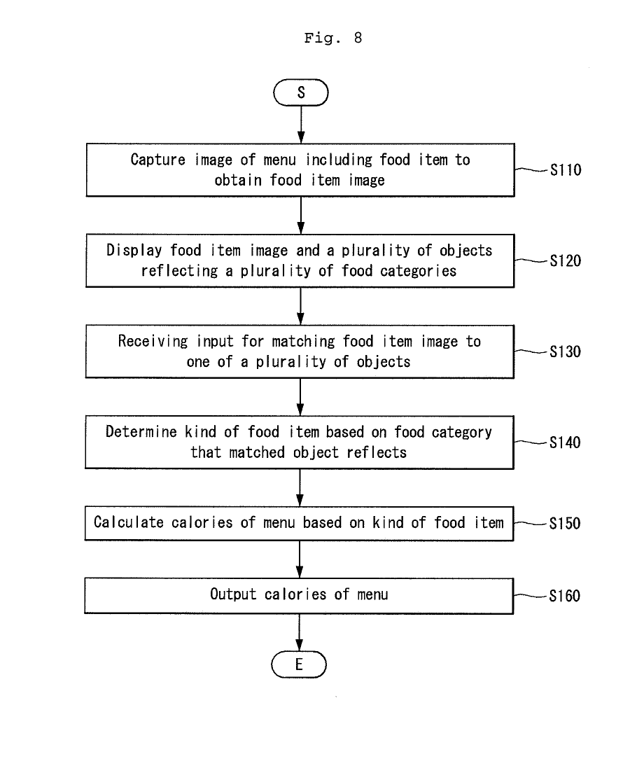

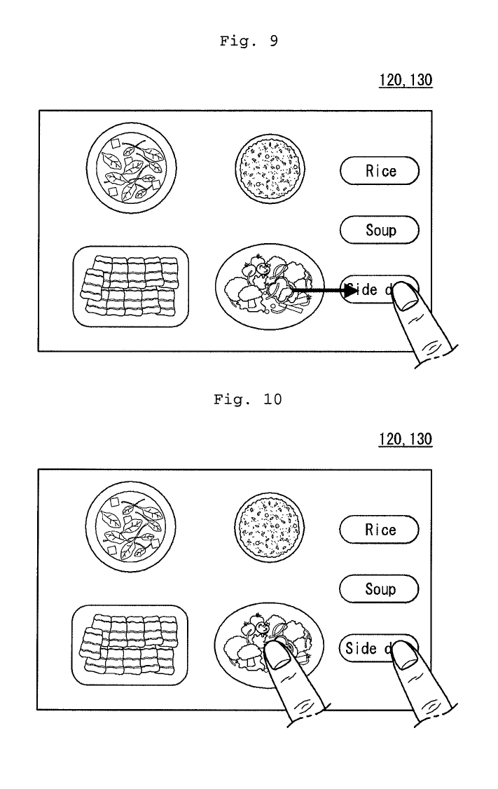

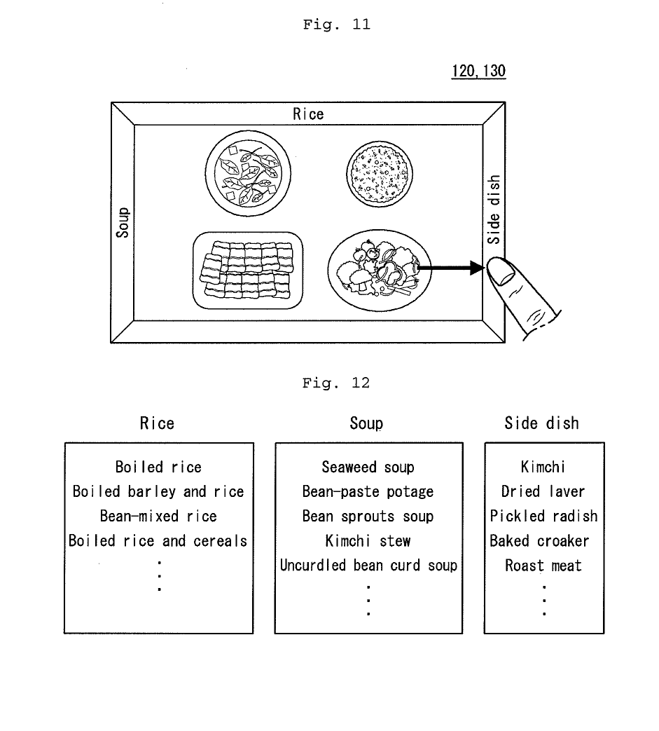

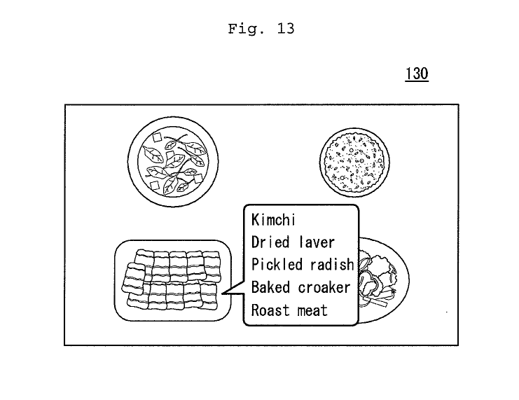

The method for a diet management according to a first exemplary embodiment of the present invention will now be described with reference to FIGS. 8 to 13. FIG. 8 is a flow chart illustrating the process of a method for a diet management according to a first exemplary embodiment of the present invention, FIG. 9 is a first view illustrating an input for matching a food item image to an object in the method for a diet management according to the first exemplary embodiment of the present invention, FIG. 10 is a second view illustrating an input for matching a food item image to an object in the method for a diet management according to the first exemplary embodiment of the present invention, FIG. 11 is a third view illustrating an input for matching a food item image to an object in the method for a diet management according to the first exemplary embodiment of the present invention, FIG. 12 is a view illustrating kinds of food items belonging to food categories according to the first exemplary embodiment of the present invention, and FIG. 13 is a view illustrating selecting of the kind of a food item in the method for a diet management according to the first exemplary embodiment of the present invention.

As shown in FIG. 8, the method for a diet management according to the first exemplary embodiment of the present invention may comprise at least one of a step (S110) of capturing an image of a menu including a food item to obtain a food item image, a step (S120) of displaying the food item image and a plurality objects reflecting a plurality of food categories, respectively, a step (S130) of receiving an input for matching the food item image to one of the plurality of objects, a step (S140) of determining the kind of a food item based on the food category reflected by the object matched to the food item image, a step (S150) of calculating the calories of the menu based on the kind of the food item, and a step (S160) of outputting the calories of the menu. The respective steps of the method for a diet management according to the first exemplary embodiment of the present invention will now be described.

The apparatus for a diet management 100 may capture an image of a menu including a food item to obtain a food item image (S110).

The camera 110 may capture an image of the menu to obtain a menu image. Here, the menu may include at least one food item, and the menu image may include at least one food item image regarding at least one food item. For example, as discussed above, as shown in FIG. 3, the camera 110 may capture an image of the menu to obtain a menu image including food item images regarding boiled rice, uncurdled bean curd soup, salad, roast meat (or Bulgogi).

The apparatus 100 for a diet management may display the food item images and a plurality of objects reflecting a plurality of food categories (S120).

The output module 130 may display the food item images. As shown in FIG. 4, the output module 130 may display the entirety or a portion of the menu image including food item images. Alternatively, the output module 130 may extract a food item image from the menu image and display only the extracted food item image.

The output module 130 may display a plurality of objects. Here, the objects may include a character, a symbol, a diagram, an icon, an image, a color, a shape, and the like, reflecting a food category. Here, the food category may refer to an upper classification including the similar kinds of food among various kinds of food. For example, the food category may include rice, a food category including the kinds of food such as boiled rice, boiled barley and rice, and the like, soup, a food category including the kinds of food such as seaweed soup, bean-paste potage, and the like, side dish, a food category including the kinds of food such as kimchi, dried layer, pickled radish, and the like. In FIG. 4, the objects are displayed as characters, but the objects may not necessarily be outputted as characters and may be displayed, for example, as a picture of a boiled rice in case of a food category reflecting boiled rice.

The apparatus 100 for a diet management may receive an input for matching a food item image to one of a plurality of objects (S130).

The input module 120 may receive an input or a signal for matching a food item image from the user to a particular object. The input module 120 may receive such a signal in various manners.

For example, the input module 120 may receive an input for allowing a displayed food item image and at least a portion of one of the plurality of objects to overlap on the screen. The input module 120 may thus obtain the input of matching the food item image to the one overlap object. In detail, as shown in FIG. 6, the input module 120 may be configured as a touch screen and receive a touch input for drag-and-dropping a particular object among the plurality of displayed objects to a particular food item image among the plurality of food item images. The input module 120 may thus obtain the input of matching the particular food item image to the particular object. Or, as shown in FIG. 9, the input module 120 may be configured as a touch screen to receive a touch input of drag-and-dropping a particular food item image among the plurality of displayed food item images to a particular object among the plurality of objects.

For another example, as shown in FIG. 10, the input module 120 may be configured as a touch screen to receive a touch input regarding a particular food item image among the plurality of displayed food item images and a touch input regarding a particular object among the plurality of objects. The input module 120 may thus obtain an input for matching the particular food item image to the particular object. In detail, the input module 120 may receive an input for simultaneously multi-touching a particular food item image and a particular object. Or, the input module 120 may receive an input for touching a particular food item image and receive an input for touching a particular object, or the input module 120 may receive the inputs in reverse order.

For another example, as shown in FIG. 11, the output module 130 may provide a plurality of objects reflecting a plurality of food categories, respectively, to a certain area of the screen, and the input module 120 may receive a touch input regarding a food item image. Here, the touch input may be a gesture for moving a food item image in a direction in which a particular object among the plurality of objects is displayed. Namely, the input module 120 may not necessarily receive a touch signal for making a particular object overlap with at least a portion of a food item image through drag-and-dropping operation and receive a touch input of moving a food item image toward a particular object as displayed from its output position.

For another example, the input module 120 may receive a touch input regarding a food item image and receive a voice signal regarding a food category.

The input module 120 may receive an input for matching a food item image to a food category from the user through various methods as described above. However, the method of obtaining such inputs by the input module 120 may not be limited to the foregoing examples and may include various other similar methods.

The apparatus 100 for a diet management may determine the kind of a food item based on a food category an object matched to a food item image reflects (S140).

The controller 170 may decide a particular food category a particular object matched to a food item image by the input module reflects. The controller 170 may determine the kind of a food item based on the particular food category.

Here, the storage unit 150 may store the kinds of food by food category. For example, as shown in FIG. 12, the storage unit 150 may store the kinds of food such as boiled rice, boiled barley and rice, bean-mixed rice, boiled rice and cereals, and the like, by a food category of rice, store the kinds of food such as seaweed soup, bean-paste potage, bean sprouts soup, kimchi stew, and the like, by a food category of soup, and store the kinds of food such as kimchi, dried layer, pickled radish, baked croaker, roast meat, and the like, by a food category of side dish. Or, the storage unit 150 may store the kinds of food and information regarding food categories to which the kinds of food belong. For example, the kinds of food such as boiled rice, boiled barley and rice, bean-mixed rice, and the like may be stored in the storage unit 150, and information indicating that such kinds of food belong to the food category of rice may be stored.

The controller 170 may determine the kind of a food item based on a particular food category by using the information stored in the storage unit 150. The controller 170 may obtain the kinds of food belonging to a particular food category from the storage unit 150 based on the foregoing particular food categories, select one kind of food, and decide the kind of a food item.

For example, the controller 170 may control the output module 130 to display the kinds of food belonging to a particular food category, obtain an input for selecting one kind of food through the input module 120, and determine the kind of food according to such an input. As shown in FIG. 13, when the food category is side dish, the output module 130 may display the kinds of food such as kimchi, dried lever, pickled radish, baked croaker, roast meat, and the like, and the input module 120 may receive a signal for selecting one of the kinds of food from the user. The controller 170 decides the kind of food accordingly.

For another example, the controller 170 may obtain the kinds of food belonging to a food category reflected by an object matched to a food item image from the storage unit 150, and select one kind of food based on the food item image among the kinds of food, thus determining the kind of food. Based on a color pattern or a shape pattern of food item images, the controller 170 may decide the kind of food having the same image pattern or the kind of food having the most similar image pattern, among the kinds of food belonging to a particular food category, as the kind of food item. In detail, the controller 170 may determine a food category of a food item as rice through the input module 120, and obtain the kinds of food such as boiled rice, boiled barley and rice, bean-mixed rice, and the like, belonging to rice. Here, the food may be bean-mixed rice, and the food item image may be a white and green image in which white rice and green beans are mixed to have a certain pattern. The controller 170 may decide the bean-mixed rice as the kind of food, among the kinds of food such as boiled rice, boiled barley and rice, bean-mixed rice, and the like, on the basis of the food item image.

The apparatus for a diet management 100 may calculate the calories of a menu based on the kinds of food (S150).

The controller 170 may calculate the calories of a menu based on the kinds of food. The storage unit 150 may store the calories of the kinds of food. The controller 170 may calculate the calories of a menu based on the calories according to the kinds of food determined as described above and the calories according to the kinds of food stored in the storage unit 150. For example, when the menu includes boiled rice, uncurdled bean curd soup, and salad, the calories of boiled rice may have been stored as 500 kcal, the calories of uncurdled bean curd soup may have been stored as 150 kcal, and the calories of salad may have been stored as 100 kcal in the storage unit 150, and the controller 170 may calculate the calories of the menu as a total of 750 kcal based on the stored calories.

The apparatus for a diet management 100 may output the calories of the menu (S160).

The output module 130 may output the thusly calculated calories. For example, the output module 130 may display the calculated calories or output the same as a voice image.

The method for a diet management according to the first exemplary embodiment of the present invention has the effect that because the kind of food is determined based on an image of a menu captured by the camera 110 and an input related to a food category of a food item and the calories of the menu is calculated and provided to the user, the user can recognize the calories of the menu. Thus, the user can control his dietary life according to the calories of the menu. In addition, the user can control his meal suitably for his health and disease management by using such information.

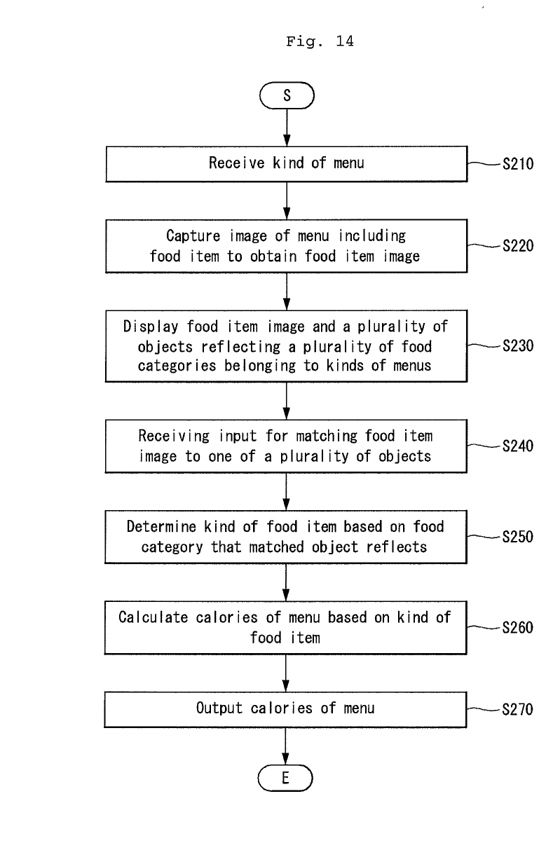

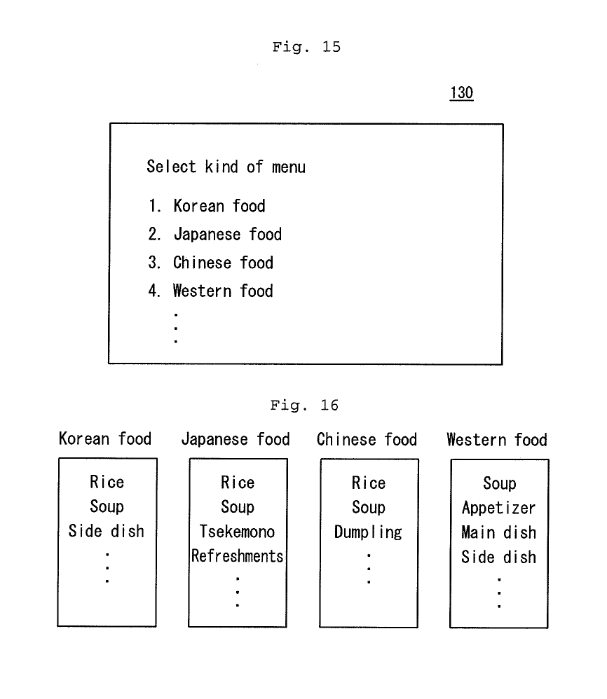

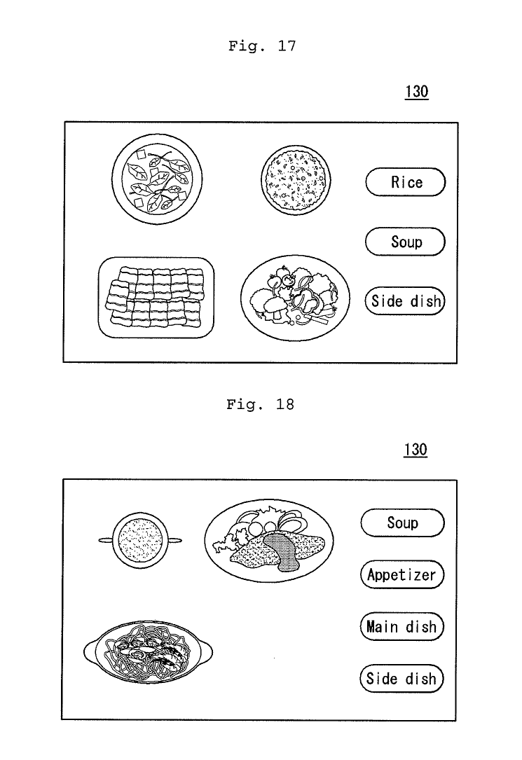

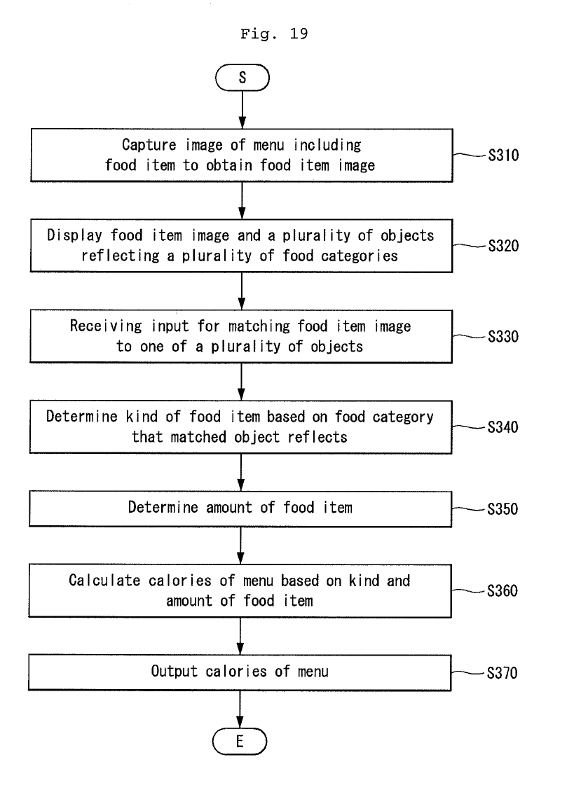

Hereinafter, a method for a diet management according to a second exemplary embodiment of the present invention will be described with reference to FIGS. 14 to 18. FIG. 14 is a flow chart illustrating the process of a method for a diet management according to a second exemplary embodiment of the present invention. FIG. 15 is a view illustrating selecting of kinds of menus in the method for a diet management according to the second exemplary embodiment of the present invention. FIG. 16 is a view illustrating food categories belonging to kinds of menus in the method for a diet management according to the second exemplary embodiment of the present invention. FIG. 17 is a first view illustrating an output of food categories belonging to the kinds of menus in the method for a diet management according to the second exemplary embodiment of the present invention. FIG. 18 is a second view illustrating an output of food categories belonging to the kinds of menus in the method for a diet management according to the second exemplary embodiment of the present invention.

As shown in FIG. 14, the method for a diet management according to the second exemplary embodiment may comprise at least one of a step (S210) of receiving a menu kind of a menu, a step (S220) of capturing an image of a menu including a food item to obtain a food item image, a step (S230) of displaying the food item image and a plurality objects reflecting a plurality of food categories belonging to the kind of menu, respectively, a step (S240) of receiving an input for matching the food item image to one of the plurality of objects, a step (S250) of determining the kind of a food item based on the food category reflected by the object matched to the food item image, a step (S260) of calculating the calories of the menu based on the kind of the food item, and a step (S270) of outputting the calories of the menu. The respective steps of the method for a diet management according to the second exemplary embodiment of the present invention will now be described. The step (S220) of capturing an image of a menu including a food item to obtain a food item image, the step (S240) of receiving an input for matching the food item image to one of the plurality of objects, the step (S250) of determining the kind of a food item based on the food category reflected by the object matched to the food item image, the step (S260) of calculating the calories of the menu based on the kind of the food item, and the step (S270) of outputting the calories of the menu may be the same as the foregoing content of the method for a diet management according to the first exemplary embodiment of the present invention.

The apparatus 100 for a diet management may receive a menu kind of a menu (S210).

The input module 120 may a menu kind of a menu. Here, the menu kind may include a menu kind according to regions such as Korean food, Chinese food, Japanese food, Western food, and the like, a menu kind according to meal time such as morning time, lunch time, dinner time, a late-night meal, and the like. The input module 120 may receive such menu kinds according to various methods.

For example, as shown in FIG. 15, the output module 130 may display at least one menu kind on the screen, and the input module 120 may receive an input for selecting one of the menu kinds. For another example, the input module 120 may receive a voice signal regarding a menu kind.

A food item image and a plurality of objects reflecting a plurality of food categories belonging to the kinds of menus may be displayed (S230).

As described above in the method for a diet management according to the first exemplary embodiment, the output module 130 may display a food item image and a plurality of objects. Here, the plurality of objects may reflect food categories belonging to the received menu kinds.

The storage unit 150 may store food categories according to the respective menu kinds. For example, as shown in FIG. 16, the storage unit 150 may store Korean food, Japanese food, Chinese food, Western food, and the like, as menu kinds, store food categories such as rice, soup, side dish, and the like, for the Korean food, store food categories such as rice, soup, tsekemono, refreshments, and the like, for the Japanese food, store food categories such as soup, appetizer, main dish, side dish, and the like, for the Western food.

The controller 170 obtains a menu kind through the input module 120, and control the output module 130 to output objects reflecting the food categories belonging to the obtained menu kind. For example, as shown in FIG. 17, when the Korean food is obtained as a menu kind, the controller 170 may control the output module 130 to provide objects reflecting rice, soup, and side dish. For another example, as shown in FIG. 18, when the Western food is obtained as a menu kind, the controller 170 may control the output module 130 to provide objects reflecting soup, appetizer, main dish, and side dish.

The method for a diet management according to the second exemplary embodiment has the effect that because the food categories according to the various menu kinds are provided as objects to the user, the user can more conveniently decide a food category of food items.

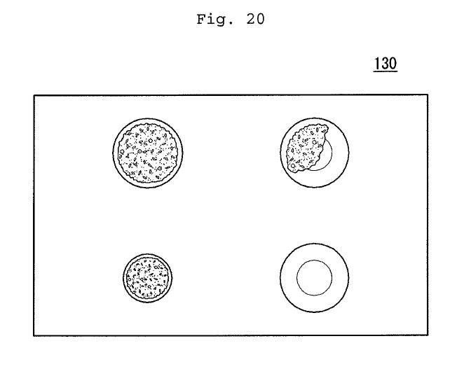

Hereinafter, a method for a diet management according to a third exemplary embodiment of the present invention will be described with reference to FIGS. 19 and 20. FIG. 19 is a flow chart illustrating the process of a method for a diet management according to a third exemplary embodiment of the present invention, and FIG. 20 is a view illustrating determining of the amount of food items in the method for a diet management according to the third exemplary embodiment of the present invention.

As shown in FIG. 19, the method for a diet management according to the third exemplary embodiment may comprise at least one of a step (S310) of capturing an image of a menu including a food item to obtain a food item image, a step (S320) of displaying the food item image and a plurality objects reflecting a plurality of food categories, respectively, a step (S330) of receiving an input for matching the food item image to one of the plurality of objects, a step (S340) of determining the kind of a food item based on the food category reflected by the matched object, a step (S350) of determining the amount of the food item, a step (S360) of calculating the calories of the menu based on the kind and amount of the food item, and a step (S370) of outputting the calories of the menu. The respective steps of the method for a diet management according to the third exemplary embodiment of the present invention will now be described. The step (S310) of capturing an image of a menu including a food item to obtain a food item image, the step (S320) of displaying the food item image and a plurality objects reflecting a plurality of food categories, respectively, the step (S330) of receiving an input for matching the food item image to one of the plurality of objects, the step (S340) of determining the kind of a food item based on the food category reflected by the matched object, and the step (S370) of outputting the calories of the menu may be the same as the foregoing content of the method for a diet management according to the first exemplary embodiment of the present invention.

The apparatus 100 for a diet management may determine the amount of a food item (S350).

The controller 170 may determine the amount of a food item. The controller 170 may determine the amount of a food item based on a food item image. The controller 170 may determine the amount of food item based on the size of the food item image. For example, the controller 170 may obtain the food item image as shown in FIG. 20 through the camera 110. In detail, FIG. 20 illustrates a large plate filled with boiled rice, a large plate half-filled with boiled rice, a large empty plate, and a small plate filled with boiled rice. Here, the controller 170 may determine the amount of the food item according to the area of the food item image. In detail, the controller 170 may determine that the amount of the boiled rice entirely filling the large plate is the largest, the amount of boiled rice half-filling the large plate is the second-largest, and the amount of the food item of the plate emptied as a food item thereon has been all eaten is the smallest. Also, the controller 170 may determine that the amount of the food item of the boiled rice entirely filling the small plate is smaller than the boiled rice filling the large plate.

The sizes of the images may change depending on the distance at which the camera 100 captures their images, so the controller 170 may correct the sizes of the food item images. Or, the output module 130 may provide image capture guide information before the camera 110 performs image capturing. The user may capture an image of a food item at a pre-set distance according to the image capture guide information, to thereby prevent the size of the food item image from changing according to the image capture distance.

The apparatus 100 for a diet management may calculate the calories of the menu based on the kind and amount of the food item (S360).

The controller 170 may calculate the calories of the menu in consideration of the kind and amount of the food item. The storage unit 150 stores calories per certain amount according to kinds of food items, and the controller 170 may obtain information regarding calories per certain amount from the storage unit 150 in consideration of the kinds of food items, and calculate calories of a food item in consideration of the amount of the food item as well. The controller 170 may calculate the calories of each of food items included in the menu and calculate the calories of the menu based on it.

The method for a diet management according to the third exemplary embodiment of the present invention has the effect that because the calories of the menu is calculated further in consideration of the amount of a food item as well as the kind of the food item, more accurate calories of the menu can be provided to the user.

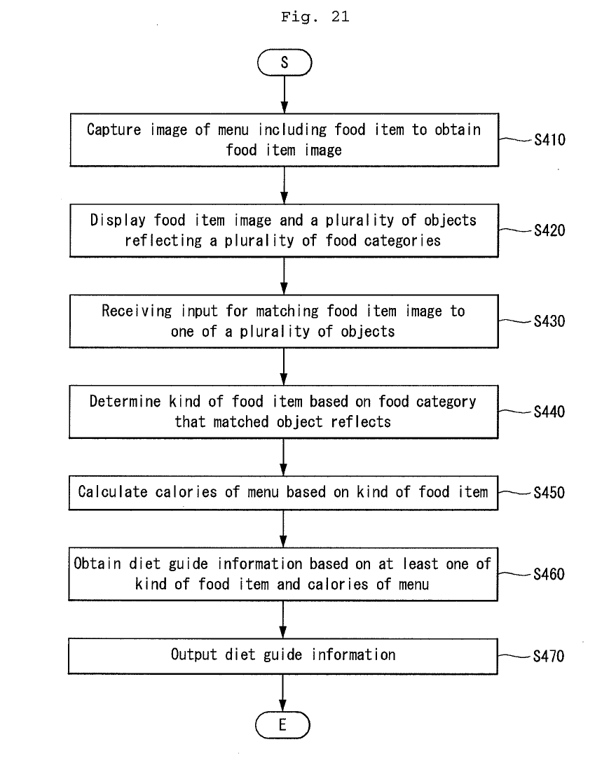

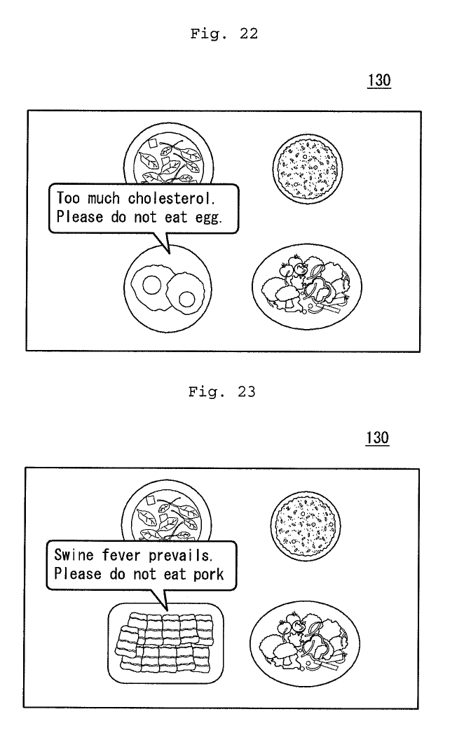

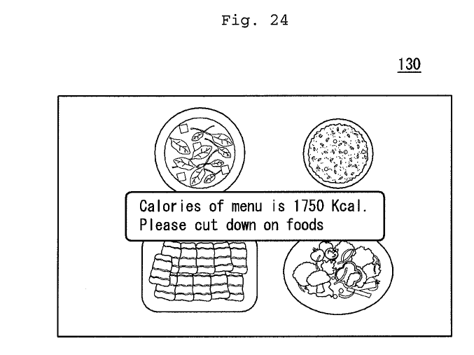

Hereinafter, a method for a diet management according to a fourth exemplary embodiment of the present invention will be described with reference to FIGS. 21 to 24. FIG. 21 is a flow chart illustrating the process of a method for a diet management according to a fourth exemplary embodiment of the present invention. FIG. 22 is a first view illustrating an output of diet guide information in the method for a diet management according to a fourth exemplary embodiment of the present invention. FIG. 23 is a second view illustrating an output of diet guide information in the method for a diet management according to a fourth exemplary embodiment of the present invention. FIG. 24 is a third view illustrating an output of diet guide information in the method for a diet management according to a fourth exemplary embodiment of the present invention.

As shown in FIG. 21, the method for a diet management according to the fourth exemplary embodiment of the present invention may at least one of a step (S410) of capturing an image of a menu including a food item to obtain a food item image, a step (S420) of displaying the food item image and a plurality objects reflecting a plurality of food categories, respectively, a step (S430) of receiving an input for matching the food item image to one of the plurality of objects, a step (S440) of determining the kind of a food item based on the food category reflected by the matched object, a step (S450) of calculating the calories of the menu based on the kind of the food item, a step (S460) of obtaining diet guide information based on at least one of the kind of the food item and the calories of the menu, and a step (S470) of outputting the diet guide information. The respective steps of the method for a diet management according to the fourth exemplary embodiment of the present invention will now be described. The a step (S410) of capturing an image of a menu including a food item to obtain a food item image, the step (S420) of displaying the food item image and a plurality objects reflecting a plurality of food categories, respectively, the step (S430) of receiving an input for matching the food item image to one of the plurality of objects, the step (S440) of determining the kind of a food item based on the food category reflected by the matched object, and the step (S450) of calculating the calories of the menu based on the kind of the food item may be the same as the foregoing content of the method for a diet management according to the first exemplary embodiment of the present invention.

The apparatus 100 for a diet management may obtain diet guide information based on at least one of the kind of a food item and the calories of a menu (S460). Also, the apparatus 100 for a diet management may output the diet guide information (S470).

The controller 170 may obtain diet guide information based on at least one of the kind of a food item and the calories of a menu. Here, the diet guide information may be information for guiding a diet of the user, which can provide various types of information to the user.

For example, the controller 170 may determine whether or not there is an avoidance food among the determined type of food items. Here, the avoidance food may refer to a kind of food which may well be avoided to be ingested by user. The storage unit 150 stores the user's physical information, and the controller 170 may determine an avoidance food item based on the stored physical information. Here, the physical information may include the user's name, age, gender, medical history, blood pressure, blood sugar level, cholesterol level, and various types of other biometrical information. The controller 170 may determine an avoidance food item by using the information. As shown in FIG. 22, when the user has too much cholesterol, the controller 170 may decide egg as an avoidance food item and control the output module 130 to output a warning message when egg is included in a menu. Such a warning message may include an instruction of preventing the ingestion of egg and its reason, a content indicating that the user has too much cholesterol, egg will be harmful to the user. Or, the communication module 140 may receive information regarding the avoidance food item from an external device. The controller 170 determines the avoidance food through such information and control the controller 170 to output a warning message when the kind of the food item corresponds to the avoidance food item. For example, as shown in FIG. 23, when a swine fever is prevalent, the controller 170 may obtain information indicating that a swine fever is prevalent through the communication module 140 and determine pork-related food as avoidance food, and when food corresponds to pork-related food, the controller 170 may control the output module 130 to output a warning message that the user should withhold ingestion of pork because swine cholera is prevalent.

For another example, the controller 170 may provide diet guide information according to the calories of a menu. The controller 170 may compare pre-set calories and the calories of the menu and provide a diet guide. Here, the storage unit 150 may store the user's physical information, and the controller 170 may calculate the pre-set calories in consideration of the physical information. Here, the pre-set calories may be a recommended calorie intake (or a standard calorie intake). As shown in FIG. 24, when the calories of the menu is higher than the recommended calorie intake, the controller 170 may control the output module 130 to output a warning message indicating that the user should cut down on a repast.

The method for a diet management according to the fourth exemplary embodiment of the present invention has the effect that because customized diet guide information comprehensively in consideration of various types of information such as the kind of a food item, the calories of a menu, rather than merely providing simple calories of the menu, is provided to the user, the user can more effectively perform a diet management.

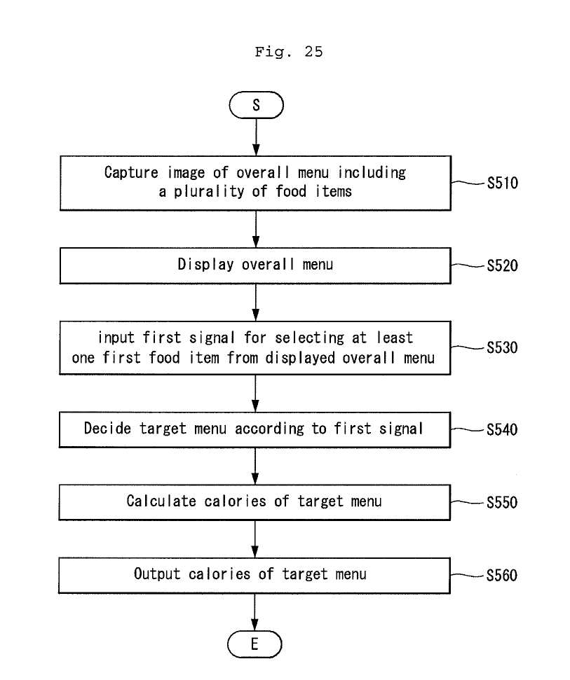

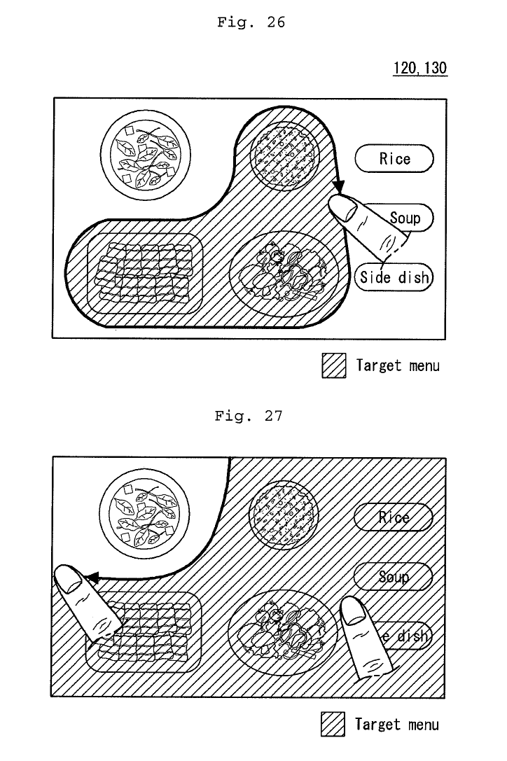

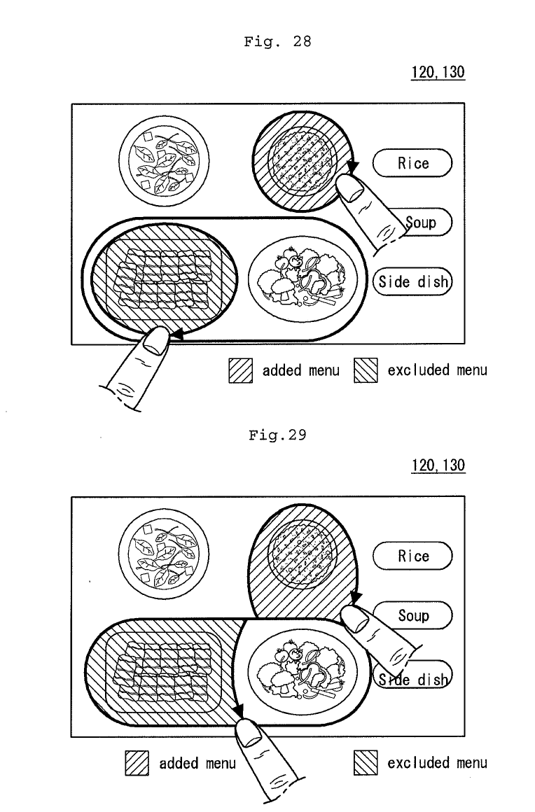

Hereinafter, a method for a diet management according to a fifth exemplary embodiment of the present invention will be described with reference to FIGS. 25 to 29. FIG. 25 is a flow chart illustrating the process of a method for a diet management according to a fifth exemplary embodiment of the present invention. FIG. 26 is a first view illustrating selecting of at least a portion of a menu in the method for a diet management according to the fifth exemplary embodiment of the present invention. FIG. 27 is a second view illustrating selecting of at least a portion of a menu in the method for a diet management according to the fifth exemplary embodiment of the present invention. FIG. 28 is a first view changing selecting of at least a portion of a menu in the method for a diet management according to the fifth exemplary embodiment of the present invention. FIG. 29 is a second view illustrating changing of at least a portion of a menu in the method for a diet management according to the fifth exemplary embodiment of the present invention.

As shown in FIG. 25, the method for a diet management according to the fifth exemplary embodiment of the present invention may comprise at least one of a step (S510) of capturing an image of an overall menu including a plurality of food items, a step (S520) of displaying the captured overall menu, a step (S530) of receiving a first signal for selecting first at least one food item among the displayed overall menu, a step (S540) of deciding a target menu according to the first signal, a step (S550) of calculating the calories of the target menu, and a step (S560) of outputting the calculated calories of the target menu. The respective steps of the method for a diet management according to the fifth exemplary embodiment of the present invention will now be described.

The apparatus 100 for a diet management may capture an image of an overall menu including a plurality of food items (S510). The camera 110 may capture the image of the overall menu to obtain a corresponding image. Here, the overall menu may include a plurality of food items, and the image of the overall menu may include an image of the plurality of food items.

The apparatus 100 for a diet management may display the overall menu (S520). The output module 130 of the apparatus 100 for a diet management may display the overall menu. The controller 170 may control the output module 130 to display the image captured by the camera 110.

The apparatus 100 for a diet management may input a first signal for selecting first at least one food item from the displayed overall menu (S530). The input module 120 may receive the first signal for selecting first at least one food item from the plurality of food items included in the overall menu. The input module 120 may receive the first signal in various manners.

First, the input module 120 may receive a signal for selecting a certain area, namely, a first area, from among the entire areas of the image of the overall menu displayed on the output module 130. Here, the first area may be an area in which at least one food item is displayed.

For example, as shown in FIG. 26, the input module 120 may obtain a touch signal regarding a first path on the image of the overall menu displayed on the touch screen. The first path may form a looped curve, and here, the first area may be an area at an inner side of the looped curve. Also, the food item displayed on the first area may be first at least one food item.

For another example, as shown in FIG. 27, the input module 120 may obtain a touch signal for generating a path dividing the image of the overall menu into a plurality of areas through the touch screen, and receive a signal for selecting one of the plurality of the divided areas. Here, the one selected area may be the first area. Also, likewise, a food item displayed on the first area may refer to first at least one food item.

Second, the input module 120 may receive a signal for selecting first at least one food item from the displayed image of the plurality of food items according to the image of the overall menu displayed on the output module 130. For example when the overall menu includes first to third food items, the output module 130 may display first to third food items and the input module 120 may receive a touch signal for selecting the first and second food items through the touch screen. Accordingly, the at least one food item may include the first and second food items.

When the first signal is received through the input module 120, the output module 130 may display the fact that the first at least one food item has been selected, for user's recognition. For example, the output module 130 may display a path according to a touch input applied to the input module 120 or may display the selected first area such that it is discriminated from the overall menu. In detail, the output module 130 may discriminately display the selected area such that the other non-selected areas are displayed in black or have a lower chroma or brightness, and the like. However, the method of discriminating the selected area from the other areas by the output module 130 is not limited to this example and may include various other methods. For another example, the output module 130 may output the first at least one selected food item such that it is displayed to be discriminated or differentiated from the other food items.

The apparatus 100 for a diet management may decide a target menu according to the first signal (S540). The controller 170 may obtain the first signal from the input module 120 and decide a target menu according to the first signal. Here, the target menu may refer to a portion of the overall menu, namely, some of the plurality of food items included in the overall menu. The controller 170 may recognize at least one selected first food item according to the first signal and decide a target menu including the first at least one food item.

Or, the communication module 140 of the apparatus 100 for a diet management may transmit the image obtained by capturing the overall menu and the first signal to an external device, e.g., the diet management server 10, and upon receiving the same, the external device may decide a target menu according to the image of the overall menu and the first signal.

The apparatus 100 for a diet management may calculate the calories of the target menu (S550). The controller 170 may calculate the calories of the target menu. The method for calculating the calories of the target menu by the controller 170 may be the same as the method for calculating the calories of the menu in the method for a diet management according to the first exemplary embodiment of the present invention as described above. But, here, the calories of the target menu including first at least one food item, instead of the calories of the overall menu, may be calculated.

Or, upon receiving the image of the overall menu and the first signal from the apparatus 100 for a diet management, the external device, e.g., the diet management server 10, may calculate the calories of the target menu and transmit the same to the apparatus 100 for a diet management. In this case, the communication module 140 may receive the calories of the target menu from the external device, and the controller 170 may obtain the calories of the target menu from the communication module 140.

The apparatus 100 for a diet management may output the calories of the target menu (S560). The output module 130 may output the calories of the target menu calculated by the controller 170. Here, the apparatus 100 for a diet management may also output diet guide information together. The controller 170 may control the output module 130 to output the diet guide information according to the calories of the target menu. The controller 170 may control the output module 130 to output the diet guide information in consideration of the user's physical information as well. In this case, the user's physical information may have been stored in the storage unit 160. Or, the communication module 140 may receive the physical information from the external device. Or, the communication module 140 may receive the diet guide information from the external device such as the diet management server or the like, and the controller 170 may control the output module to output such diet guide information. Here, the diet guide information may be information for helping the user's diet management. The diet guide information may include, for example, whether or not the calories of the target menu is greater than the predetermined calories, namely, the standard calorie intake for the a meal and information whether or not the user must reduce the size of his meal accordingly. Also, the diet guide information may be generated by utilizing the user's age, gender, blood pressure, blood sugar level, and the like. The controller 170, the diet management server 10, or the like, may perform a diet guide by utilizing the user's physical information. For example, a woman would have a smaller size of meal than a man, and a diabetic may be provided with a diet guide in consideration of his blood sugar level.

Meanwhile, the apparatus 100 for a diet management may change the target menu. In a state in which the target menu is determined according to the first signal, the apparatus 100 for a diet management may receive a second signal and change the target menu accordingly. Here, the changing of the target menu may include adding a food item not included in the target menu, to the target menu or excluding a food item included in the target menu from the target menu.

The input module 120 may input the second signal for selecting second at least one food item among the displayed overall menu. The input module 120 may receive the second signal in various manners.

First, the input module 120 may receive a signal for selecting a certain area, namely, a second area, from the entire area of the image of the overall menu displayed on the output module 130. Here, the second area may be an area in which at least one food item is displayed.

For example, as shown in FIG. 28, the input module 120 may receive the second signal regarding a certain path formed on the image of the overall menu. The path may include a looped curve, and an internal area of the looped curve may be the second area. In this case, the second area may be an area on which the second at least one food item is displayed.

For another example, as shown in FIG. 29, the input module 130 may receive the second signal regarding a certain path formed on the image of the overall menu. In this case, the output module 130 may display the target menu such that the target menu is discriminated of differentiated from the overall menu. The certain path according to the second signal may be combined with a portion of the looped curve displayed to discriminate the area of the target menu to form a certain area. Here, the certain area may be a second area in which the second at least one food item is displayed.

Second, the input module 120 may obtain a signal for selecting second at least one food item from among the plurality of food items displayed by the image of the overall menu displayed on the output module 130. For example, the input module 120 may obtain a touch signal for selecting an image of a food item through the touch screen.

When the second signal regarding second at least one food item is received through the input module 120, the controller 170 may change the target menu according to the second signal. Here, the controller 170 may exclude a food item, which is included in the target menu before the target menu is changed (referred to as a ‘former target menu’, hereinafter), among the second at least one food item selected according to the second signal, from the target menu, and add a food item not included in the former target menu, among the second at least one food item, to the current target menu. As shown in FIGS. 28 and 29, when the input module 120 receives a signal for selecting the second area, the controller 170 may exclude a food item displayed at a portion overlapping with the area of the target menu in the second area, from the target menu. Also, the controller 170 may add a food item displayed at a portion not overlapping with the area of the target menu in the second area, to the target menu. Meanwhile, the apparatus 100 for a diet management may transmit the second signal to the external device, e.g., the diet management server, or the like, and the external device may change the target menu according to the second signal.

When the target menu is changed, the apparatus 100 for a diet management may calculate the calories of the changed target menu. The controller 170 may calculate the calories of the changed target menu according to the same method as the method of calculating the calories described above. Also, the controller 170 may calculate the calories of the changed target menu such that the calories of the food item added to the target menu or removed from the target menu is added to the already calculated calories of the former target menu or subtracted therefrom. Meanwhile, the calculation of the calories may be performed by the external device, e.g., the diet management server 10, and the communication module 140 may receive the corresponding results.

When the changed calories of the target menu are obtained, the apparatus 100 for a diet management may control the output module 130 to output the changed calories. In this case, the controller 170 may control the output module 130 to output the calories of the former target menu, the calories of the current target menu (namely, the calories of the changed target menu), and the difference between the calories of the former target menu and the calories of the current target menu.

The method for a diet management according to the fifth exemplary embodiment of the present invention has the effect that the user can recognize the calories of a portion of the overall menu. The apparatus 100 for a diet management can provide the calories of the target menu among the overall menu to the user, so the user can select various target menus and receive corresponding calorie information. Thus, the user can notice which food item of the overall menu is desirable to be ingested.

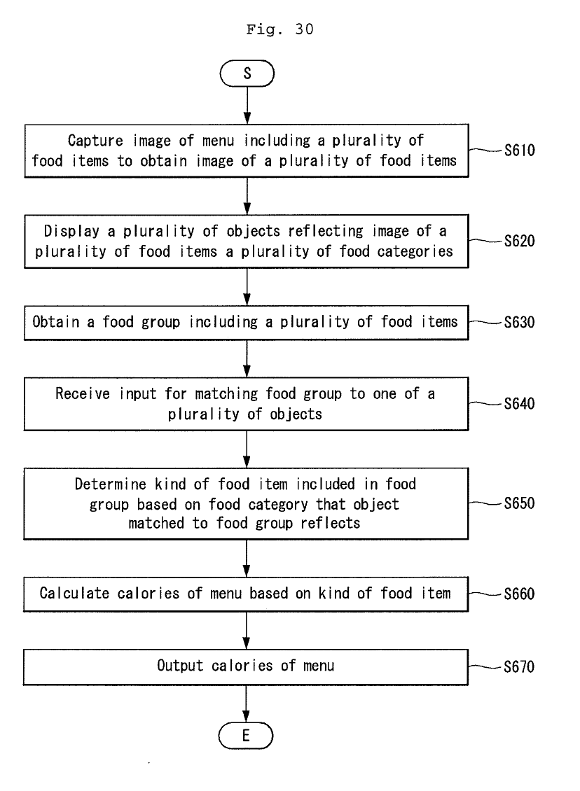

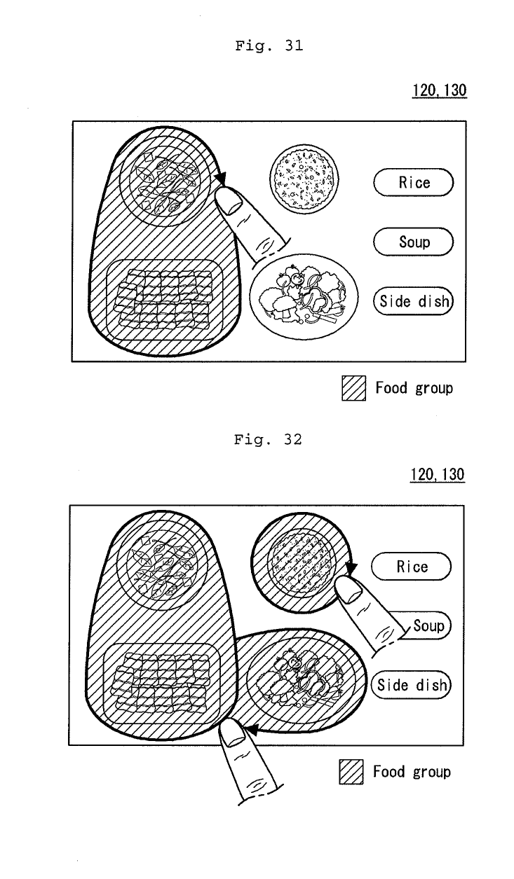

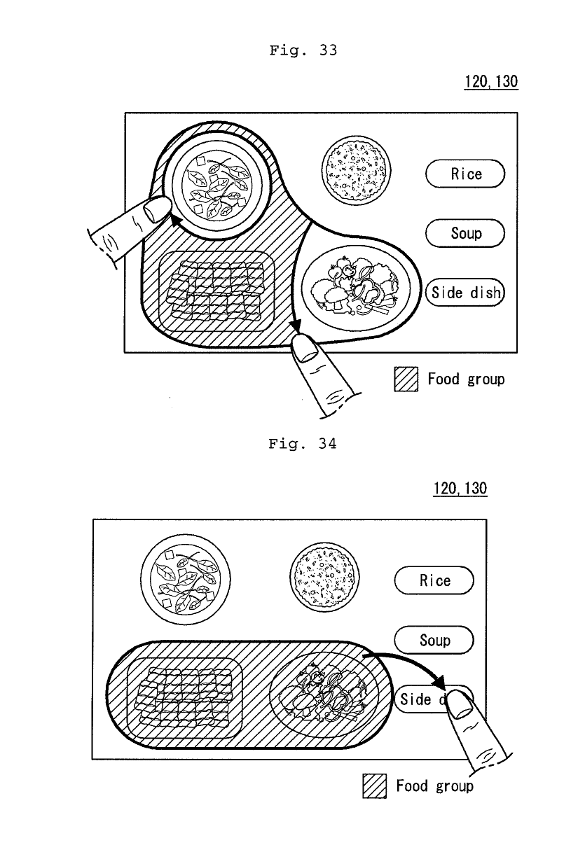

A method for a diet management according to a sixth exemplary embodiment of the present invention will now be described with reference to FIGS. 30 to 34. FIG. 30 is a flow chart illustrating the process of a method for a diet management according to a sixth exemplary embodiment of the present invention. FIG. 31 is a view illustrating setting of a food group in the method for a diet management according to the sixth exemplary embodiment of the present invention. FIG. 32 is a view illustrating adding of a food group in the method for a diet management according to the sixth exemplary embodiment of the present invention. FIG. 33 is a view illustrating excluding of a food group in the method for a diet management according to the sixth exemplary embodiment of the present invention. FIG. 34 is a view illustrating matching of a food group to an object in the method for a diet management according to the sixth exemplary embodiment of the present invention.

As shown in FIG. 30, a method for a diet management according to the sixth exemplary embodiment of the present invention may comprise at least one of a step (S610) of capturing an image of a menu including food items to obtain a plurality of food item images, a step (S620) of displaying a plurality of objects reflecting the plurality of food item images and a plurality of food categories, respectively, a step (S630) of obtaining a food item group including a plurality of food items, a step (S640) of receiving an input for matching the food item group to one of the plurality of objects, a step (S650) of determining the kind of food items included in the food item group based on the food category reflected by an object matched to the food item group, a step (S660) of calculating the calories of the menu based on the kind of the food items, and a step (S670) of outputting the calories of the menu. The respective steps of the method for a diet management according to the sixth exemplary embodiment of the present invention will now be described. The step (S660) of calculating the calories of the menu based on the kind of the food items and the step (S670) of outputting the calories of the menu may be the same as the foregoing content of the method for a diet management according to the first exemplary embodiment of the present invention.

The apparatus 100 for a diet management may capture an image of a menu including food items to obtain a plurality of food item images (S610). The camera 110 may capture the image of the menu including a plurality of food items to obtain a plurality of food item images.

The apparatus 100 for a diet management may display the plurality of food item images and a plurality of objects reflecting the plurality of food categories, respectively (S620). The output module 130 may display the plurality of food item images captured by the camera 110. The apparatus 100 for a diet management may obtain a food item group including the plurality of food items (S630).

The input module 120 may obtain an input for selecting at least one of the plurality of food items according to the plurality of displayed food item images, and the controller 170 may set at least one food item as a food item group according to the input. The input module 120 may receive an input for selecting at least one of the plurality of food items in various manners.

For example, as shown in FIG. 31, the output module 130 may provide the plurality of food item images to the user, and the input module 120 may receive a touch input for forming a particular area, and the controller 170 may set at least one food item included in the particular area as a food item group according to the input. Here, the method of receiving the touch input to form the particular area may be the same as the method of receiving an input for selecting a target menu according to the fifth exemplary embodiment of the present invention as described above.

The apparatus 100 for a diet management may change the food item group. For example, as shown In FIGS. 32 and 33, the input module 120 may receive an input for adding a food item to the food item group or an input for excluding a food item from the food item group, and the controller 170 may change the food item group accordingly. Here, the method of changing the food item group may be performed in the same manner as the method of changing the target menu in the method for a diet management according to the fifth exemplary embodiment of the present invention as described above.

The apparatus 100 for a diet management may receive an input for matching the food item group to one of the plurality of objects (S640). The input module 120 may receive an input for matching the set food item group to one of the plurality of objects, and the controller 170 may decide at least one food category included in the food item group according to the food category reflected by the object matched to the food item group accordingly. The method of matching the food item group to the object by the input module 120 may be the same as the method of receiving an input for matching the food item image to the object in the method for a diet management according to the first exemplary embodiment of the present invention as described above. In this case, however, as shown in FIG. 34, the food item group including at least one food item, rather than one food item image, may be matched to the object.

The apparatus 100 for a diet management may determine the kind of a food item included in the food item group based on the food category reflected by the object matched to the food item group (S650). The controller 170 may decide the food category of the at least one food item included in the food item group as a food category reflected by the object matched to the food item group.

The method for a diet management according to the sixth exemplary embodiment of the present invention has the effect that, when a menu includes a plurality of food items, a food category of food items belonging to the same food category can be selected at a time, rather than selecting a food category with respect to each one of the food items, so the user can conveniently select the food category.

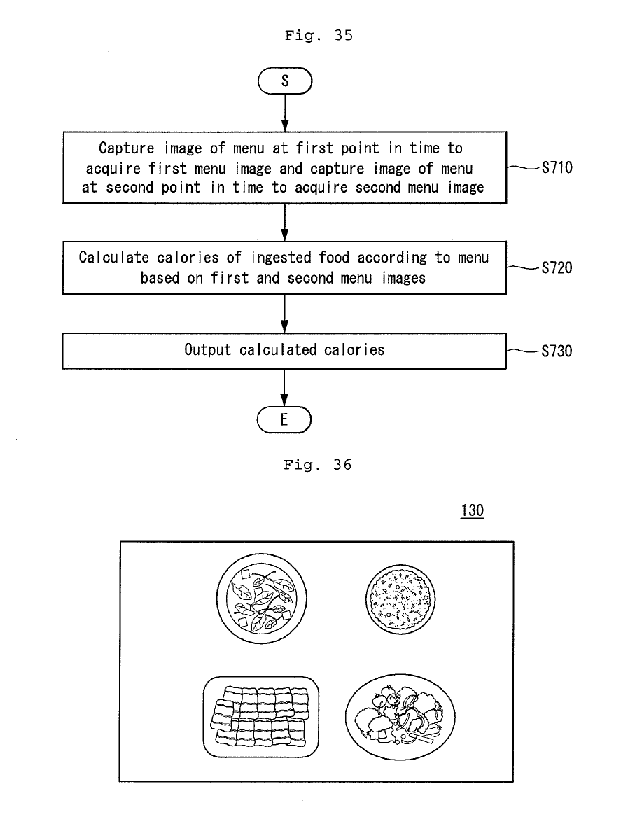

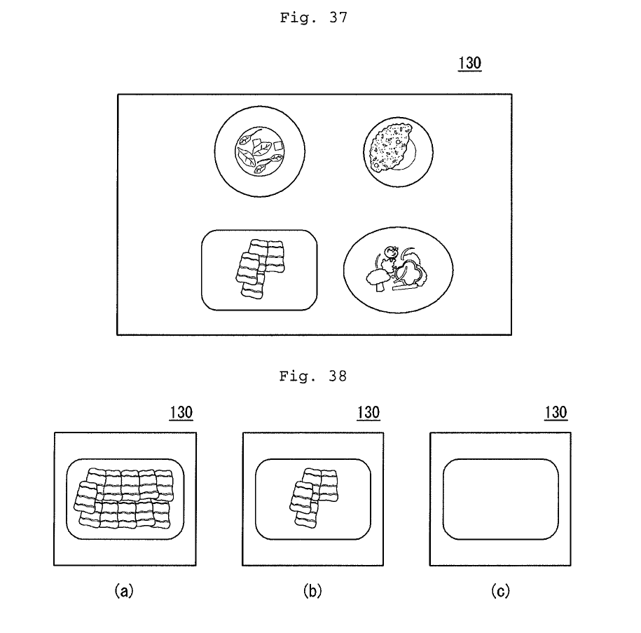

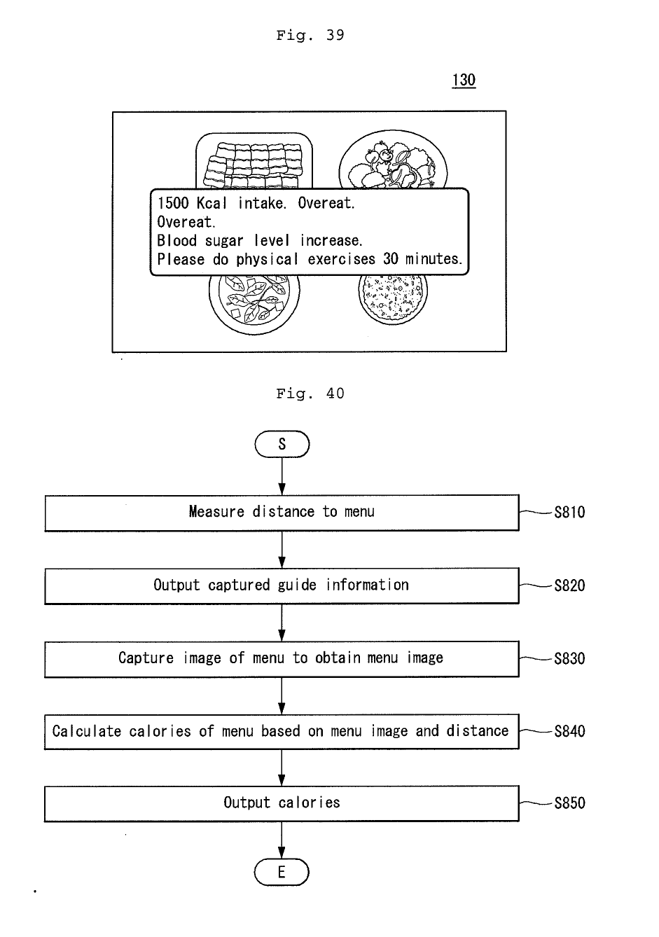

Hereinafter, a method for a diet management according to a seventh exemplary embodiment of the present invention will be described with reference to FIGS. 35 to 39. FIG. 35 is a flow chart illustrating the process of a method for a diet management according to a seventh exemplary embodiment of the present invention. FIG. 36 is a view illustrating a first menu image regarding a menu at a first time point in the method for a diet management according to the seventh exemplary embodiment of the present invention. FIG. 37 is a view illustrating a second menu image regarding a menu at a second point in time in the method for a diet management according to the seventh exemplary embodiment of the present invention. FIG. 38 is a view illustrating determining of the amount of ingested food in the method for a diet management according to the seventh exemplary embodiment of the present invention. FIG. 39 is a view illustrating an output of diet guide information and exercise guide information in the method for a diet management according to the seventh exemplary embodiment of the present invention.

As shown in FIG. 35, the method for a diet management according to the seventh exemplary embodiment of the present invention may comprise at least one of a step (S710) of capturing an image of a menu at a first time point to obtain a first menu image and an image of a menu at a second point in time to obtain a second menu image, a step (S720) of calculating caloric intake according to the menus based on the first and second menu images, and a step (S730) of outputting the caloric intake. The respective steps of the method for a diet management according to the seventh exemplary embodiment of the present invention will now be described.

The apparatus 100 for a diet management may capture an image of a menu at a first time point to obtain a first menu image and an image of a menu at a second point in time to obtain a second menu image (S710). As shown in FIG. 36, the camera 110 may capture the menu at the first time point to obtain a first menu image. Here, the first time point may include a point in time before mealtime (or before a meal). The camera 110 may obtain the menu image of the menu in the same manner as described above in the method for a diet management according to the first exemplary embodiment of the present invention. Here, the camera 110 may obtain the menu image before mealtime by capturing the image of the menu before mealtime. Also, as shown in FIG. 37, the camera 110 may obtain a second menu image by capturing an image of a menu at a second point in time. Here, the second point in time may include a point in time after mealtime.

The camera 110 may obtain the menu image of the menu in the same manner as described above in the method for a diet management according to the first exemplary embodiment of the present invention. Here, the camera 110 may obtain the menu image after mealtime by capturing the image of the menu after mealtime. The storage unit 150 may store the first and second menu images captured by the camera 110.

The apparatus 100 for a diet management may calculate caloric intake according to the menu based on the first and second menu images (S720). The controller 170 may calculate caloric intake according to the menu based on the first and second menu images. In this case, the controller 170 may calculate the caloric intake according to the menu in various manners.

The controller 170 may calculate caloric intake according to the menu based on the kind of food items included in the menu and intake of food items. The controller 170 may determine the kinds of the food items and intake of food items based on the first and second menu images.

The controller 170 may determine the kind of food items included in the menu based on the first menu image. The method of determining the kind of food items included in the menu by the apparatus 100 for a diet management may be the same as described above in the method for a diet management according to the first exemplary embodiment of the present invention.

The controller 170 may determine the kind of a food item through an image analysis by using a first image of a food item included in the first menu image. Or, the controller 170 may transmit the first image of the food item to the external device, e.g., the diet management server 10, through the communication module 140, the diet management server 10 may determine the kind of the food item by using the first image, and the controller 170 may receive the kind of food item from the external device and decide the kind of the food item based on the received kind of food item. Or, the output module 130 may output the first menu image and an object reflecting a food category, the input module 120 may obtain an input for matching a first image of a food item included in the first menu image and the object, and the controller 170 may determine a food category of the food item according to the input and determine the kind of a food item most similar to the first image of the food item among the kinds of food items belonging to the food category as the kind of the food item.

The controller 170 may determine intake of a food item based on the first and second menu images. Here, the first menu image may be a menu image before mealtime, and the second menu image may be a menu image after mealtime.

The controller 170 may determine intake of a food item by comparing a first image of a food item included in the menu image before mealtime and a second image of a food item included in the menu image after mealtime. Here, the controller 170 may determine intake of a food item by comparing the sizes of the first and second images. Here, the first image may relates to the food item before mealtime, which may reflect the total amount of the food item, and the second image may relate to the food item after mealtime, which may reflect a remaining amount of the food item after the user have the meal.

For example, when the first image is an image of a food item before mealtime as shown in FIG. 38(a), the second image may be an image of a food item after mealtime as shown in FIG. 38(b), the controller 170 may determine the amount of the food item before mealtime and the amount of the food item after mealtime based on the size or area of the image of the food item, and determine the amount of the ingested food item based on it. In this case, the controller 170 may determine that the first and second images are related to the same food item based on image patterns, e.g., the color, an individual form, shape, and the like, of the food item appearing on the first and second images. Or, the controller 170 may determine that the first and second images are related to the same food based on the form, size, and color of the plates appearing on the first and second images.

For another example, when the first image is an image of a food item before mealtime as shown in FIG. 38(a) and a second image is an image of a food item-emptied state after mealtime as shown in FIG. 38(c), the controller 170 may determine the amount of the food item before mealtime based on the size or area of the image of the food item before mealtime and determine the amount of the food item before mealtime as the amount of ingested food item. In this case, because there is no food appearing on the second image, the controller 170 may determine that the first and second images are related to the same food item based on the shape, size, form, color, and the like of the plate and determine the intake of the food item based on it.

The controller 170 may determine the kind of food item and intake of the food item and calculate caloric intake according to the menu based on the determined kind of food item and the determined intake of the food item.

The apparatus 100 for a diet management may output the caloric intake (S730). The output module 130 may output the caloric intake calculated by the controller 170. Here, the output module 130 may output various types of information helping the user's health management besides the caloric intake. Here, the information helping the user's health management may include diet guide information and health guide information. The controller 170 may control the output module 130 to output at least one of the caloric intake, the diet guide information, and the health guide information. The controller 170 may generate the information by using the caloric intake or receive the information from the external device through the communication module 140. For example, the storage unit 150 may store the user's physical information, the controller 170 may obtain the diet guide information and exercise guide information in consideration of the caloric intake and the physical information comprehensively, and the output module 130 may provide the diet guide information and exercise guide information to the user. For example, as shown in FIG. 39, the output module 130 may output the intake of a food item, the diet guide information, and the exercise guide information. Here, the diet guide information may include the user's physical information and information for a diet control. Here, the exercise guide information may include a type of an exercise to be done by the user, an exercise location, and the like, after mealtime.

The communication module 140 may transmit the caloric intake to the external device, e.g., the diet management server 10. The diet management server 10 may collect and store such information. Also, the diet management server 10 may provide the information to various devices. For example, the diet management server 10 may provide the information to a doctor's terminal, a terminal of a drug store, a personal computer, and the like. Accordingly, a doctor, a pharmacist, dietitian, a health manager, and so on, may obtain the information regarding the user's diet and comprehensively and collectively manage the user's health.

The method for a diet management according to the seventh exemplary embodiment of the present invention has the effect that accurate intake of a food item can be obtained by comparing a menu before mealtime and a menu after mealtime.

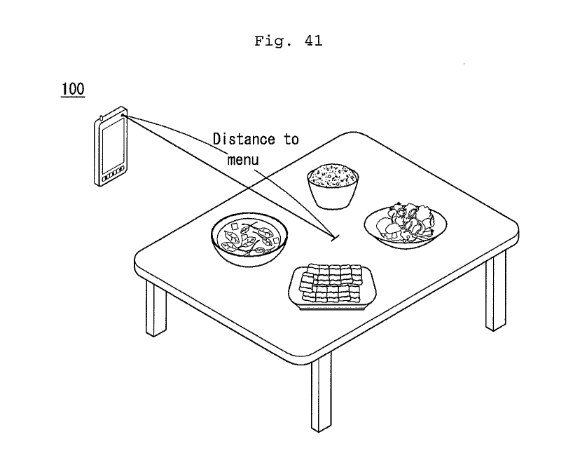

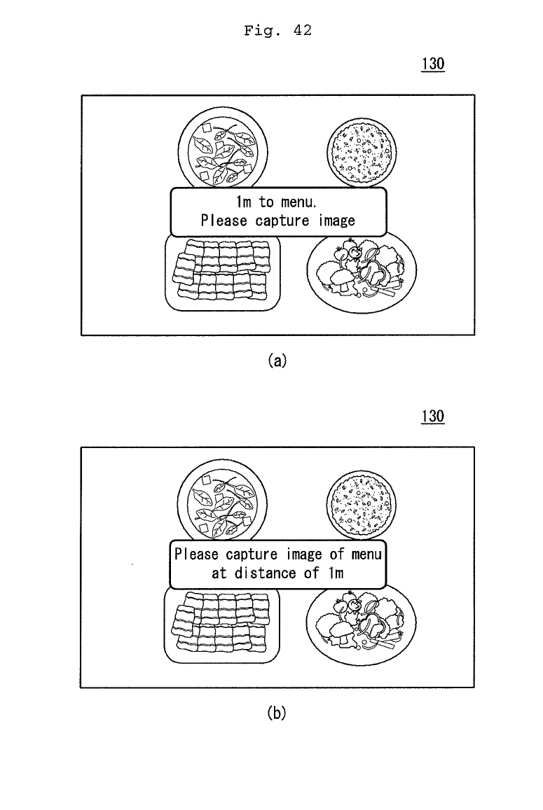

Hereinafter, a method for a diet management according to an eighth exemplary embodiment of the present invention will be described with reference to FIGS. 41 to 42. FIG. 40 is a flow chart illustrating the process of a method for a diet management according to an eighth exemplary embodiment of the present invention. FIG. 41 is a view illustrating detection of the distance to a menu in the method for a diet management according to the eighth exemplary embodiment of the present invention. FIG. 42 is a view illustrating an output of image capture guide information in the method for a diet management according to the eighth exemplary embodiment of the present invention.

As shown in FIG. 40, the method for a diet management according to the eighth exemplary embodiment of the present invention may comprise at least one of a step (S810) of measuring the distance to a menu, a step (S820) of outputting image capture guide information, a step (S830) of capturing an image of the menu to obtain a menu image, a step (S840) of calculating calories of the menu based on the menu image and the distance, and a step (S850) of outputting the calories. The respective steps of the method for a diet management according to the eighth exemplary embodiment of the present invention will now be described. The step (S830) of capturing an image of the menu to obtain a menu image and the step (S850) of outputting the calories may be the same as the foregoing content of the method for a diet management according to the first exemplary embodiment of the present invention.

The apparatus 100 for a diet management may measure the distance to a menu (S810). As shown in FIG. 41, a distance detection unit 160 may include a sensor for measuring a distance. For example, the distance detection sensor 160, as an optical sensor, irradiates light and receives light reflected from the menu, thus measure the distance from the apparatus 100 for a diet management to the menu. In this case, the distance detection unit 160 may generate a signal reflecting the detected distance and transmit the same to the controller 170.

The apparatus 100 for a diet management may output image capture guide information (S820). Here, the image capture guide information may include information regarding a distance to the menu from a location where the camera 110 captures an image of the menu when the user captures the image of the menu, information indicating an angle at which the camera 110 captures the image of the menu, and the like. The controller 170 may control the output module to output the image capture guide information based on the distance measured by the distance detection unit 160. For example as shown in FIG. 42(a), the controller 170 may control the output module 130 to output the image capture guide information including information reflecting the distance detected by the distance detection unit 160. For another example, the controller 170 may control the output module 130 to output the image capture guide information including information for guiding image capturing by comparing the detected distance to the menu and a predetermined image capture distance. In detail, when the image capture distance is 1 m and the distance to the menu is 1.5 m, the output module 130 may output a message indicating that the user should capture an image at a closer location, and when the distance to the menu is 0.5 m, the output module 130 may output a message indicating that the user should capture an image at a farther location. For another example, as shown in FIG. 42(b), the controller 170 may control the output module 130 to output a message indicating a predetermined image capture distance. For another example, the controller 170 may control the output module 130 to output a message guiding the user to capture an image of the menu vertically or horizontally according to an angle for capturing the image of the menu.

The apparatus 100 for a diet management may calculate the calories of the menu based on the menu image and the distance (S840). The controller 170 may calculate the calories of the menu based on the menu image and the distance. In the method for a diet management according to the first exemplary embodiment of the present invention, the calories of a menu may be calculated based on a menu image. In the method for a diet management according to the first exemplary embodiment of the present invention, the controller 170 may determine the amount of a food item in consideration of the distance to the menu as well. For example, the controller 170 may determine the amount of a food item based on the size of the image of the food item obtained by capturing the menu, and in this case, the size of the image of the food item may change depending on the distance to the menu. Thus, the controller 170 may correct the size of the image of the food item in consideration of the distance to the menu as well, and determine the amount of the food item accordingly. The controller 170 may calculate the calories of the menu based on the determined amount of the food item and the kind of the food item.

The method for a diet management according to the eighth exemplary embodiment of the present invention has the effect that, because the apparatus 100 for a diet management provides the image capture guide information, the user can easily perform capturing, and thus, the apparatus 100 for a diet management can obtain more accurate images of the menu and the food item. In addition, because the calories of the menu are calculated in consideration of even the distance to the menu, more accurate calories of the menu can be calculated.

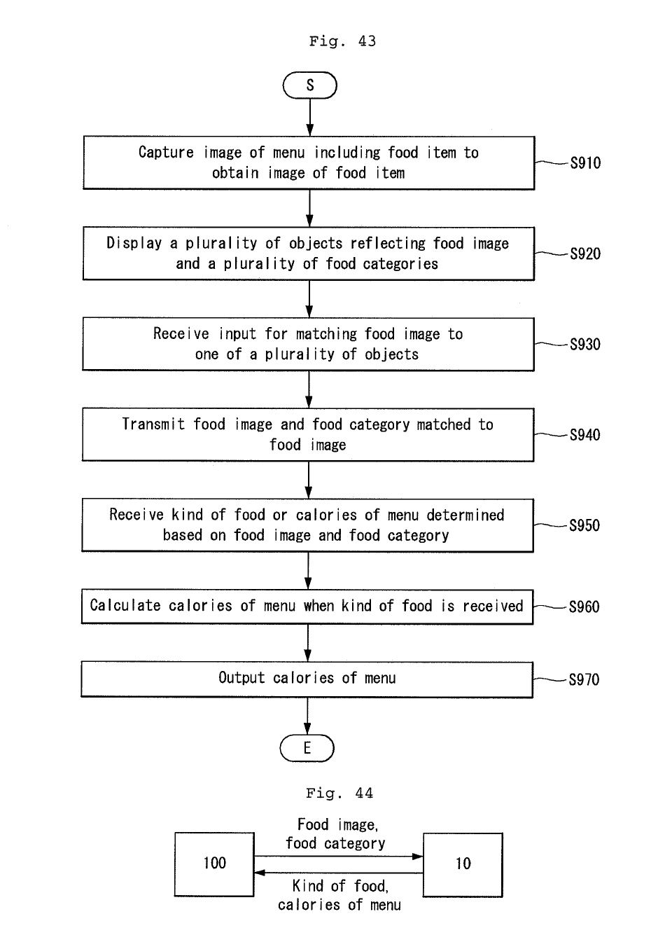

Hereinafter, a method for a diet management according to a ninth exemplary embodiment of the present invention will be described with reference to FIGS. 43 and 44. FIG. 43 is a flow chart illustrating the process of a method for a diet management according to a ninth exemplary embodiment of the present invention. FIG. 44 is a view illustrating the communication module 140 in the method for a diet management according to the ninth exemplary embodiment of the present invention.

As shown in FIG. 43, the method for a diet management according to the ninth exemplary embodiment of the present invention may comprise at least one of a step (S910) of capturing an image of a menu including a food item to obtain a food item image, a step (S920) of displaying the food item image and a plurality of objects reflecting a plurality of food categories, respectively, a step (S930) of receiving an input for matching the food item image to one of the plurality of objects, a step (S940) of transmitting the food item image and the food category of the object matched to the food item image, a step (S950) of receiving the kind of the food item determined based on the food item image and the food category and the calories of the menu, a step (S960) of calculating the calories of the menu based on the kind of the food item when the kind of the food item is received, and a step (S970) of outputting the calories of the menu. The respective steps of the method for a diet management according to the ninth exemplary embodiment of the present invention will now be described. The step (S910) of capturing an image of a menu including a food item to obtain a food item image, the step (S920) of displaying the food item image and a plurality of objects reflecting a plurality of food categories, respectively, the step (S930) of receiving an input for matching the food item image to one of the plurality of objects, and the step (S970) of outputting the calories of the menu may be the same as the foregoing content of the method for a diet management according to the first exemplary embodiment of the present invention.

The apparatus 100 for a diet management may transmit a food item image and a food category of an object matched to the food item image (S940). As shown in FIG. 44, the communication module 140 may transmit the food item image and the food category matched to the food item image to an external device. Here, the external device may include the diet management server 10. The diet management server 10 may manage information regarding diet such as collecting, storing, and providing information regarding the diet, analyze the information regarding the diet, and obtain the calories of a menu, diet guide information, and exercise guide information.

The apparatus 100 for a diet management may receive the kind of a food item determined based on the food item image and the food category, or the calories of the menu (S950). As shown in FIG. 44, the communication module 140 may receive the kind of the food item, the calories of the menu, the diet guide information, the exercise guide information, and the like, from an external device. Here, the external device may include the diet management server 10. As discussed above, the diet management server 10 may receive the food item image and the food category of the object matched to the food item image from the apparatus 100 for a diet management, and obtain information regarding the user's diet including the kind of the food item, the amount of the food item, the calories of the menu, the diet guide information, and the exercise guide information. Here, the method of determining the kind of the food item and the amount of the food item by using the food item image and the food category by the diet management server 10 may be the same or similar to the method of determining the kind of a food item and the amount of the food item by using the image of the food item and the food category by the apparatus 100 for a diet management in the method for a diet management according to the first exemplary embodiment of the present invention as described above Likewise, the method of calculating the calories of the menu by the diet management server 10 is the same or similar to the method of calculating the calories of the menu by the apparatus 100 for a diet management.

When the kind of the food item is received, the apparatus 100 for a diet management may calculate the calories of the menu based on the kind of the food item (S960). The controller 170 may calculate the calories of the menu based on the received kind of the food item. Also, when the communication module 140 receive the amount of the food item from the external device, e.g., the diet management server 10, the controller 170 may calculate the calories of the menu in consideration of the amount of the food item as well.

In the method for a diet management according to the ninth exemplary embodiment of the present invention, the process of determining, obtaining, selecting or calculating the kind of the food item, the amount of the food item, the calories of the menu, the diet guide information, the exercise guide information, and the like, may be performed by the external device, e.g., the diet management server 10, instead of the apparatus 100 for a diet management. This may be applicable to the other processes in the method for a diet management according to the first to eighth exemplary embodiments of the present invention as described above.

Thus, the respective steps included in the methods for a diet management according to the first to eighth exemplary embodiments of the present invention as described above may not be necessarily performed by the apparatus 100 for a diet management, and the entire steps or some of the steps of the methods for a diet management according to the first to eighth exemplary embodiments of the present invention may be performed by the external device, e.g., the diet management server 10.

The method for a diet management according to the ninth exemplary embodiment of the present invention has the effect that, because the external device having a better performance than that of the apparatus 100 for a diet management can generate information related to a diet management and the apparatus 100 for a diet management may receive the corresponding results through communication and provide the same to the user, more accurate information can be rapidly provided to the user.

The methods for a diet management according to the respective exemplary embodiments of the present invention can be used alone or may be combined to be used. The steps constituting the respective exemplary embodiments may be used alone or may be combined with the steps constituting the other exemplary embodiments so as to be used.

The preferred embodiments of the present invention have been described with reference to the accompanying drawings, and it will be apparent to those skilled in the art that various modifications and variations can be made in the present invention without departing from the scope of the invention. Thus, it is intended that any future modifications of the embodiments of the present invention will come within the scope of the appended claims and their equivalents.

The invention thus being described, it will be obvious that the same may be varied in many ways. Such variations are not to be regarded as a departure from the spirit and scope of the invention, and all such modifications as would be obvious to one skilled in the art are intended to be included within the scope of the following claims.

What is claimed is:

1. An apparatus for a diet management, the apparatus comprising:
a camera configured to capture an image of an overall menu of food;
an output module configured to display the overall menu;
an input module configured to receive a first signal for selecting at least one food item from the displayed overall menu; and
a controller configured to decide a target menu including the at least one food item based on the first signal, to calculate calories of the target menu, and to output the calculated calories of the target menu.

2. The apparatus of claim 1, wherein the first signal is a signal for selecting a first area from the entire area of the displayed overall menu, and
wherein the first area is an area in which the selected at least one food item is displayed.

3. The apparatus of claim 1, wherein the input module is configured to receive a second signal for selecting at least a second food item from the displayed overall menu, and
wherein the controller is configured to change the target menu according to the second signal, to calculate calories of the changed target menu, and to output the calculated calories of the changed target menu.

4. The apparatus of claim 3, wherein, when the selected at least second food item was not included in the target menu, the controller is configured to change the target menu by adding the selected at least second food item to the target menu.

5. The apparatus of claim 3, wherein, when the selected at least second food item was included in the target menu, the controller is configured to change the target menu by excluding the selected at least second food item from the target menu.

6. The apparatus of claim 3, wherein the second signal is a signal for selecting a second area from the entire area of the displayed overall menu, and
wherein the second area is an area in which the selected at least second food item is displayed.

7. The apparatus of claim 1, wherein the controller is configured to determine a kind and an amount of the at least one food item included in the target menu based on the captured image of the overall menu, and to calculate the calories of the target menu based on the kind of the at least one food item.

8. The apparatus of claim 1, wherein the controller is configured to control the output module to output menu guide information based on the calories of the target menu.

9. An apparatus for a diet management, the apparatus comprising:
a camera configured to capture an image of an overall menu of food;
an output module configured to display the overall menu;
an input module configured to receive a first signal for selecting at least one food item from the displayed overall menu;
a communication module configured to communicate with a diet management server; and
a controller configured to transmit the captured image of the overall menu and the first signal to the diet management server via the communication module, to receive calories of a target menu including the at least one food item from the diet management server via the communication module, and to control the output module to output the calories of the target menu,
wherein the diet management server is configured to decide the target menu including the at least one food item according to the first signal, and to calculate the calories of the target menu.

10. The apparatus of claim 9, wherein the input module is configured to receive a second signal for selecting at least a second food item from the displayed overall menu, the controller is configured to transmit the second signal to the diet management server via the communication module, and the diet management server is configured to change the target menu according to the second signal.

11. The apparatus of claim 10, wherein, when the selected at least second food item was not included in the target menu, the diet management server adds the selected at least second food item to the target menu.

12. The apparatus of claim 10, wherein, when the selected at least second food item was included in the target menu, the diet management server excludes the selected at least second food item from the target menu.

13. The apparatus of claim 9, wherein the controller is configured to receive diet guide information from the diet management server via the communication module, and to control the output module to output the diet guide information, and
wherein the diet management server is configured to store a user's physical information, and to generate the diet guide information based on the physical information and the calories of the target menu.

14. An apparatus for a diet management, the apparatus comprising:
a camera configured to capture an image of a menu of food;
an output module configured to display the menu and a plurality of food categories;
an input module configured to receive a signal for matching at least one food item from the displayed menu to one of the food categories of the plurality of food categories; and
a controller configured to calculate calories of the at least one food item based on the matched food categories, and to output the calculated calories of the at least one food item.

15. The apparatus of claim 14, wherein the input module is configured to receive signals for matching all food items from the displayed menu to corresponding food categories of the plurality of food categories, and
wherein the controller is configured to calculate calories of all food items from the displayed menu, and to output a total of all the calculated calories of all food items from the displayed menu.

16. A method for providing diet management, the method comprising:
capturing, by a camera, an image of an overall menu of food;
displaying the captured image of the overall menu;
receiving a first signal for selecting at least one food item from the displayed overall menu;
deciding a target menu including the selected at least one food item according to the first signal;
calculating calories of the target menu; and
outputting the calculated calories of the target menu.

17. The method of claim 16, further comprising:
receiving a second signal for selecting at least a second food item from the displayed overall menu;
changing the target menu according to the second signal;
calculating the calories of the changed target menu; and
outputting the calculated calories of the changed target menu.

18. The method of claim 17, wherein, when the selected at least second food item was not included in the target menu, changing the target menu by adding the selected at least second food item to the target menu.

19. The method of claim 17, wherein, when the selected at least second food item was included in the target menu, changing the target menu by excluding the selected at least second food item from the target menu.

20. The method of claim 17, further comprising:
storing a user's physical information;
generating diet guide information based on the physical information and the calories of the target menu; and
outputting the diet guide information.
